(19) United States
(12) Patent Application Publication
(10) Pub. No.: US 2010/0279733 A1
(43) Pub. Date: Nov. 4, 2010

(54) NETWORKING APPLICATION

(75) Inventors: Peter Olof Karsten, Greater London (GB); Ran Rimon, Greater London (GB); Karlis Zigurs, Greater London (GB); Martin Rogan, Greater London (GB)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: CECURE GAMING LIMITED, London, Greater London (GB)

(21) Appl. No.: 12/447,445

(22) PCT Filed: Oct. 24, 2007
(86) PCT No.: PCT/EP2007/061445

§ 371 Date: Jul. 7, 2010

(30) Foreign Application Priority Data
Oct. 27, 2006 (GB) 0621433.2
Nov. 27, 2006 (GB) 0623659.0
May 1, 2007 (GB) 0708431.2

(51) Int. Cl. H04W 88/06

(52) U.S. Cl. 455/552.1

(57) ABSTRACT

A networking system for a mobile communication device. The system comprises a connection module for establishing a connection with a remote device using any of a plurality of communication protocols and a protocol selector for selecting a communication protocol from the plurality of communications protocols for use in attempting establishment of the connection. Each of the plurality of communications protocols have a pre-determined priority, and the selection means is configured to select a first of the protocols according to its priority. The connection module may be configured to establish the further connection in response to receipt of the request.

The present invention relates to a networking application for a mobile communication device, and to an associated mobile device. This invention also relates to an apparatus for hosting a networking application, and to an associated server. The invention also relates to a communications method and to a communications system.

According to a first aspect of the invention, there is provided a networking application for a mobile communication device, the device being capable of communicating in accordance with a plurality of communication protocols, said application comprising means for identifying a desired communication protocol, means for configuring the device to communicate using the desired communication protocol, and means for establishing a network connection using the desired protocol, whereby communication in accordance with the desired communication protocol enhances the operation of the application.

Preferably, the configuration means is adapted to configure at least one network connection setting of the device.

Preferably, the configuration means is adapted to modify at least one network connection setting of the device.

Preferably, the configuration means is adapted to enable a particular network communications protocol on the device.

Preferably, the configuration means is adapted to automatically configure the device.

Preferably, the configuration means is adapted to reattempt to configure the device in the event that upon an attempt to configure the device the configuration means fails to configure the device.

Preferably, the application is adapted to reattempt to configure the device a predetermined number of times.

Preferably, the configuration means is adapted to read information relating to an existing network connection setting of the device thereby to determine whether the device has previously been configured to operate in accordance with a particular communication protocol.

Preferably, the configuration means is adapted to read Access Point Names (APN) settings stored on the device.

Preferably, the identification means comprises a parameter which identifies the desired communication protocol.

Preferably, the network connection means is adapted to attempt to establish the network connection once the device has been configured.

Preferably, the network connection means is adapted to reattempt to establish the network connection in the event that the network connection means fails to establish the network connection.

Preferably, the network connection means is adapted to wait a predetermined length of time prior to reattempting to establish a network connection. Preferably, the length of time is determined in dependence on the network protocol used for the network connection. For TCP/IP connections the latency is approximately of the order of 1 second, and hence the predetermined length of time is preferably in the range of 1 to 5 seconds. For HTTP and WAP connections the latency is around 10 to 20 seconds and hence the predetermined length of time is preferably in the range of 20 to 30 seconds.

Preferably, the connection means is adapted to attempt to establish the network connection using an existing network connection setting of the device.

Preferably, the connection means is adapted to attempt to establish a network connection between the application and a first remote device, the network address details of said remote device being stored on the mobile device.

Preferably, the connection means is adapted to attempt to establish a network connection between the application and at least one further similar remote device, the address details of said remote device being stored on the mobile device, in the event that a connection cannot be established with the first remote device.

Preferably, the remote device includes a gateway, said gateway being adapted to connect a mobile telecommunications network to which the mobile device is connectable to a further communications network. More preferably, the further communications network includes the internet.

Preferably, the remote device comprises an Access Point Name (APN) and the address details include an APN address. Thus, the network connection means first attempts to connect to a first APN, and if that is not successful the network connection means then attempts to connect to a second APN.

Preferably, the desired communication protocol is a communication protocol adapted to provide an end-to-end connection. More preferably, the desired protocol is a connection oriented protocol adapted to provide a reliable data stream.

Preferably, the desired communication protocol is a socket based communication protocol.

Preferably, the desired protocol is a low level communication protocol which does not include at least one of the uppermost layers of the ISO Open System Interconnect (ISO/OSI) networking communications model. More preferably, the desired protocol does not include at least one of the following layers of the ISO/OSI model: the application layer, the presentation layer and the session layer. Yet more preferably, the desired protocol comprises the Transmission Control Protocol (TCP)/Internet Protocol (IP).

The application is preferably configured to allow a plurality of users to interact with one another whilst using the multi-user application.

The multi-user application may be configured to allow each of a plurality of users to use the multi-user application independently of each other user.

The multi-user application may be a multi-player game, preferably a multi-player which allows a plurality of players to play against one another. The multi-player game may be configured to allow a plurality of players to play independently of one another. The multi-player game may comprise a casino game, for example, poker, roulette, black jack, virtual slot machines or the like. The multi-player game may be a virtual sport for example virtual horse racing.

Preferably, the network connection means is adapted to establish a network connection using at least one further network communications protocol.

This important feature is preferably provided independently. According to another aspect of the invention, there is provided a networking application for a mobile communication device, the device being capable of communicating in accordance with a plurality of communication protocols, said application comprising means for identifying a desired communication protocol, means for configuring the device to communicate using the desired communication protocol and at least a further communications protocol, and means for establishing a network connection using the desired communication protocol and the further network communications protocol.

Preferably, the network connection means is adapted to establish a network connection using the further protocol in the event of the failure to establish a network connection using the desired protocol.

In this way a fallback network connection can be provided. Thus, instead of leaving the device unconnected in the event that it is not possible to connect using the desired communication protocol, the application attempts to establish a network connection using a further protocol.

Preferably, the further protocol is adapted to provide higher level services than those provided by an end-to-end connection.

Preferably, the further communications protocol is a higher level communications protocol than the desired protocol.

Preferably, the further communications protocol results in increased communications latency. More preferably, the further protocol includes at least one of the upper layers of the ISO/OSI networking communications model.

Preferably, the further protocol comprises the Hyper Text Transfer Protocol (HTTP) or the Wireless Application Protocol (WAP).

Preferably, the application further comprises means for transmitting a request for information relating to a network connection setting for the device, and means for receiving information relating to a network connection setting, wherein the configuration means is further adapted to configure the device in dependence on the received information.

According to a further aspect of the invention, there is provided a networking application for a mobile communication device, the device being capable of communicating in accordance with a plurality of communication protocols, said application comprising means for identifying a desired communication protocol, means for transmitting a request for information relating to a network connection setting of the device, means for receiving information relating to a network connection setting, configuration means for configuring the device to communicate in dependence on the received information, and means for establishing a network connection.

Preferably, the configuration means is adapted to configure the device to communicate in accordance with a particular communications protocol in dependence on the received information.

Preferably, the configuration means is adapted to configure the device to communicate in accordance with the desired protocol in dependence on the received information.

Preferably, the transmitting means is adapted to transmit the request over an existing network connection. In this way the application is able to use an existing network connection (using an existing protocol) to set up a desired network connection, by using the existing connection to obtain information which enables the set up of the desired connection.

Preferably, the existing network connection is in the form of a network connection which is not based on the desired communication protocol, but instead based on a further communications protocol. Thus, in this way it is possible to set up a TCP/IP connection using an HTTP connection.

Preferably, the transmitting means is adapted to transmit the request for information in the event of the failure of the configuration means to configure the device to operate in accordance with the desired communication protocol.

Preferably, the transmitting means is adapted to transmit the request for information in the event of the failure of the network connection means to establish a network connection in accordance with the desired communication protocol.

Preferably, the setting includes a network address of a remote device to which the mobile device is connectable.

Preferably, the remote device includes a gateway. Preferably, the setting includes an APN address.

More preferably, the setting includes an APN address relating an APN, said APN being adapted to be connected to using the desired communication protocol. Yet more preferably, the setting includes a TCP/IP APN address. In this way the address details of an appropriate TCP/IP APN can be established, which enables the application to establish a TCP/IP socket-based connection with that APN, and in turn connect to the internet (and hence to a remote gaming server) using a TCP/IP socket-based connection.

Preferably, the transmitting means is adapted to transmit details relating to an existing network connection along with the request.

Preferably, the details relate to an existing network connection. More preferably, the details relate to an HTTP or WAP APN to which the device is connectable.

Preferably, the transmitting means is adapted to transmit details relating to the network (and/or network operator) to which the mobile device is connectable.

Preferably, the transmitting means is adapted to transmit details relating to the mobile device along with the request.

Preferably, the application is further adapted to retrieve details relating to the mobile device automatically for inclusion in the request.

Preferably, the application is further adapted to prompt a user to input details relating to the mobile device for inclusion in the request.

Preferably, the application is further adapted to retrieve details relating to the mobile device from a tag (or watermark) applied to the application, said tag including details relating to the mobile device and having been applied to the application prior to the installation of the application on the mobile device.

Preferably, the transmitting means is adapted to transmit the request in the form of a message via a messaging application.

According to another aspect of the invention, there is provided a networking application for a mobile communication device, the device being capable of communicating in accordance with a plurality of communication protocols, said application comprising means for transmitting a request for information relating to a network connection setting of the device in the form of a message via a messaging application, means for receiving information including a network connection setting, configuration means for configuring the device to communicate in dependence on the received information, and means for establishing a network connection.

Preferably, the message is in the form of a Short Message Service (SMS) message. Alternatively, the message may be in the form of a Multimedia Messaging Service (MMS) message or an e-mail message.

Preferably, the transmitting means is adapted to request user confirmation prior to transmitting the message using the messaging application, since network charges may apply to the sending of such messages.

Preferably, the transmitting means is adapted to transmit the message automatically using the messaging application. In an embodiment, the transmitting means is adapted to interface with a native messaging application provided on the mobile device and to use this application for the transmission of messages.

Preferably, the receiving means is adapted to receive information including a network connection setting in the form of a message via the messaging application.

Preferably, the configuration means is adapted to configure the device upon receipt of the received message.

Preferably, the receiving means is adapted to receive Over-The-Air (OTA) configuration messages, and wherein the message is in the form of an OTA message.

Preferably, the application further comprises means for comparing the desired protocol with an existing communication protocol available for use on the device, and wherein the configuration means is adapted to reconfigure the device to operate in accordance with the desired protocol if the protocol comparison does not match.

According to a further aspect of the invention, there is provided a networking application for a mobile communication device, the device being capable of communicating in accordance with a plurality of communication protocols, said application comprising means for identifying a desired communication protocol, means for comparing the desired protocol with a communication protocol available for use on the device, means for reconfiguring the device to communicate using the desired communication protocol if the protocol comparison does not match, and means for establishing a network connection using the desired protocol.

Preferably, the configuration means comprises means for requesting confirmation from a user of the mobile device prior to reconfiguration.

Preferably, the application further comprises a user interface for guiding a user of the mobile device through the configuration of the network settings of the device.

Preferably, the mobile device is connectable to a wireless communications network.

Preferably, the communications network comprises at least one of the following networks: a Wireless Local Area Network (WLAN); a 2G cellular network; a 2.5G cellular network or a 3G cellular network. In particular, the communications network may be a GSM (Global System for Mobile Communications) network, a (General Packet Radio Service) GPRS network, a W-CDMA (Wideband Code Division Multiple Access)/UMTS (Universal Mobile Telecommunication System) network or a CDMA-2000 network. The network may also employ Enhanced Data rates for GSM Evolution (EDGE) technology.

Preferably, the mobile device is adapted for telephonic communications over the wireless communications network.

Preferably, the network connection means is adapted to connect the application to at least a further similar application. More preferably, the application comprises client and server portions, and the network connection means is adapted to connect the client portion of the application (running on the mobile device) to a server portion of the application running on a server. Yet more preferably, this connection is via an APN gateway.

Preferably, the application forms part of a multi-user application. More preferably, the application forms part of an online multi-player game.

Preferably, the application forms part of a gambling application.

Preferably, the (networking) application comprises a “client portion” which is connectable to a corresponding “server portion” (preferably located on a remote server). The online gaming application is preferably hosted on this server.

According to a further aspect of the invention, there is provided an apparatus for hosting a networking application which is accessible by at least one mobile device, the apparatus comprising means for connecting the apparatus to a communications network to which the mobile device is connectable, means for receiving a request from the mobile device for information relating to at least one network connection setting for connecting the mobile device to the application, and means for transmitting the network connection setting to the mobile device.

Preferably, the receiving means is adapted to receive the request in the form of a messaging application message.

Preferably, the receiving means is adapted to receive SMS messages, MMS messages or e-mail messages.

Preferably, the receiving means is adapted to receive the request via an existing network connection between the mobile device and the apparatus.

Preferably, the apparatus further comprises means for monitoring an existing network connection between a mobile device and the apparatus, means for comparing the existing network connection type with a pre-selected network connection type, and wherein the transmitting means is adapted to transmit a network connection setting associated with the pre-selected network type in the event that the existing network connection type does not match the pre-selected network connection type.

According to a further aspect of the invention, there is provided an apparatus for hosting a networking application which is accessible by at least one mobile device, the apparatus comprising means for connecting the apparatus to a communications network to which the mobile device is connectable, means for monitoring an existing network connection between the mobile device and the apparatus, means for comparing the existing network connection type with a pre-selected network connection type, and means for transmitting a network connection setting associated with the pre-selected network type to the mobile device in the event that the existing network connection type does not match the pre-selected network connection type.

Preferably, the comparing means is adapted to compare a measure of the latency associated with the existing network connection with an expected latency range thereby to compare the existing network connection type with the pre-selected network connection type.

Preferably, the use of the pre-selected network connection type enhances the operation of the application.

Preferably, the apparatus comprises means for storing at least one application for download by mobile devices, and means for recording details relating to the identity of each mobile device which initiates a download of the application.

Preferably, the downloadable application is in the form of a multi-user application.

Preferably, the downloadable application is in the form of a multi-player game.

Preferably, the downloadable application comprises the networking application as herein described. More preferably, the networking application comprises a server portion or component which is executable on the apparatus, and a client portion or component which is executable on the mobile device, which is connectable to the apparatus.

Preferably, the apparatus comprises means for tagging a downloadable application in response to a download request prior to processing the download request.

Preferably, the tagging means is adapted to tag the downloadable application with any one of the following details relating to a mobile device: the type of mobile device; the model number; and the network operator of the communications network to which the mobile device is connected.

Preferably, the apparatus further comprises means for monitoring download requests for a downloadable application stored on the apparatus, and wherein the transmitting means is adapted to transmit a network connection setting in response to a download request in the event that a download is not initiated within a predetermined length of time following the download request.

According to another aspect of the invention, there is provided an apparatus for hosting a networking application which is accessible by at least one mobile device, the apparatus comprising means for connecting the apparatus to a communications network to which the mobile device is connectable, means for storing an application for download by a mobile device; means for receiving a download request from a mobile device, and means for transmitting a network connection setting to a mobile device in the event that a download is not initiated within a predetermined length of time following the receipt of a download request.

Preferably, the receiving means is adapted to receive a download request in the form of messaging application message requesting an internet link to the downloadable application, and wherein the transmitting means is adapted to transmit an internet link to the application within a messaging application message.

Preferably, the transmitting means is adapted to transmit the network connection setting to the mobile device using a messaging application.

Preferably, the transmitting means is connectable to a Short Message Service Centre (SMSC) forming part of a communications network to which the mobile device is connectable, and wherein the transmitting means is adapted to transmit the network connection setting to the mobile device via a SMS or MMS message.

Preferably, the transmitting means is adapted to transmit the network connection setting to the mobile device in the form of an OTA configuration message.

Preferably, the transmitting means is further adapted to transmit a message containing instructions on disabling a network operator content control firewall.

Preferably, the apparatus further comprises means for logging details of all requests received by the apparatus from mobile devices relating to network connection settings, means for logging details of all transmissions from the apparatus to mobile devices relating to network connection settings, means for monitoring for the subsequent connection of each mobile device to the apparatus, and means for transmitting a follow-up customer care message to a mobile device in the event that the mobile device does not connect to the apparatus within a predetermined time interval.

According to another aspect of the invention, there is provided an apparatus which comprises means for connecting the apparatus to a communications network to which a mobile device is connectable, means for logging details of all mobile devices that attempt to establish a network connection with the apparatus, means for monitoring for the subsequent connection of each mobile device to the apparatus, and means for transmitting a follow-up customer care message to a mobile device in the event that the mobile device does not connect to the apparatus within a predetermined time interval.

Preferably, the apparatus is adapted to execute a networking application, and wherein said networking application is adapted to implement at least some of the functionality of the apparatus.

Preferably, the networking application is in the form of a client-server application, the server portion of the application being executed on the apparatus, and wherein the client portion of the apparatus is in the form of a networking application as herein described.

Preferably, the apparatus is in the form of a server connectable to a communications network.

According to another aspect of the invention, there is provided a mobile device incorporating an application as herein described.

According to a further aspect of the invention, there is provided a communications system which comprises a communications network, an apparatus as herein described connectable to the communications network, and a mobile device as herein described connectable to the communications network.

According to yet a further aspect of the invention, there is provided a method for connecting a mobile device to a server, thereby to enable a application to be executed on the mobile device and the server, the method comprising identifying a desired communication protocol, configuring the device to communicate using the desired communication protocol, and establishing a network connection using the desired protocol between the mobile device and the server, whereby communication in accordance with the desired communication protocol enhances the operation of the application.

Preferably, the method further comprises establishing a network connection using at least one further network communications protocol in the event that it is not possible to establish a network connection using the desired communication protocol.

Preferably, the method further comprises transmitting a request for information relating to a network connection setting of the device, receiving information relating to a network connection setting, and configuring the device in dependence on the received information.

Preferably, the method involves connecting a mobile device which incorporates an application as herein described to a server which comprises an apparatus as herein described.

Preferably, the network connection means is adapted to establish a further socket-based network connection.

According to another aspect of the invention, there is provided a networking application for a mobile communication device, which comprises means for establishing a first socket-based network connection with a remote device, and wherein the network connection means is adapted to establish at least a second independent socket-based network connection with the device.

In order to allow two-way communication over a socket based network connection between an application running on a mobile device and an application running on a remote device, such as a server, a full duplex communication channel may be used. However, it has been found that certain communication difficulties may arise in such circumstances. In particular, messages sent between the mobile device and the remote device may be corrupted. Such communication difficulties have been noted in particular in the case of online networking applications, such as online multiplayer games, and appear to be attributed to mismatches between the mobile devices and the remote devices, for example, timing mismatches. The provision of a pair of socket based network connections improves the quality of communication.

Preferably, the network connection means is adapted to establish the second connection once the first connection has been established.

Preferably, the network connection means is adapted to establish the second connection once a communication handshake has been completed on the first connection.

Preferably, the application comprises means for receiving a connection acknowledgment from a remote application to which the device is connectable, and wherein the network connection means is adapted to establish the second connection following receipt of the acknowledgment.

Preferably, the acknowledgment includes data representative of an application session identity associated with a connection to a remote application to which the device is connectable.

Preferably, the connection means is adapted to establish the second connection once a session has been established between the networking application and the remote application.

Preferably, the application further comprises means for configuring a communication channel to operate over at least one of the network connections.

Preferably, the channel configuration means is adapted to configure a first channel to operate as a receiving channel over the first network connection and a second channel to operate as a transmitting channel over the second network connection.

Preferably, the channel configuration means is adapted to configure at least one network connection to operate as a half duplex communication channel.

Preferably, the channel configuration means is adapted to configure each of the network connections to operate as a half duplex communication channel.

Preferably, the channel configuration means is adapted to configure at least one network connection to operate as a simplex communication channel.

Preferably, the channel configuration means is adapted to configure each of the network connections to operate as a simplex communication channel.

The provision of a pair of socket-based connections, each providing a simplex channel, further improves the quality of communication between the mobile device and the remote device, since the pair of simplex channels is more resistant to mismatches between the handset and the remote device than a single full duplex channel, as used in known systems.

Preferably, the channel configuration means is adapted to modify the configuration of each channel independently.

Preferably, the channel configuration means is adapted to configure the first network connection to be used for writing data to a remote application to which the application is connectable, and to configure the second network connection to read data from a remote application to which the application is connectable.

Preferably, the first and second socket connections are logically linked to one another.

Preferably, the application further comprises means for detecting a communication disruption on at least one of the network connections, and wherein the network connection means is adapted to establish a new network connection in the event that a communication disruption is detected.

Preferably, the network connection means is adapted to establish new first and second network connections in the event that a communication disruption is detected on one of the network connections.

Preferably, the application further comprises means for detecting a communication disruption on at least one of the network connections, and wherein the network connection means is adapted to establish a new network connection via one of the network connections in the event that a communication disruption is detected on the other of the network connections.

According to another aspect of the invention, there is provided a networking application for a mobile communication device, which comprises means for establishing first and second socket-based network connections with a remote device, means for detecting a communication disruption on at least one of the network connections, and wherein the network connection means is adapted to establish a new network connection via one of the network connections in the event that a communication disruption is detected on the other of the network connections.

Preferably, the network connection means is adapted to transmit a network connection request to a remote device to which the device is connectable thereby to establish a new network connection.

Preferably, the network connection means is adapted to transmit the request over the network connection on which a communication disruption has not been detected.

Preferably, the detecting means is adapted to detect a communication disruption in the event that data is not received on one of the network connections within a predetermined time interval.

Preferably, the application further comprises means for receiving a network connection request from a remote device to which the application is connectable, and wherein the network connection means is adapted to establish a network connection to the remote device in response to a network connection request.

Preferably, each socket-based network connection comprises a TCP connection.

Preferably, each socket-based network connection is established between the application and a similar application running on the remote device.

Preferably, the remote device is in the form of a server. More preferably, the server is connectable to the internet.

Preferably, each socket-based network connection is established via an internet gateway. More preferably, the gateway includes an APN.

Preferably, the application forms part of a multi-user application.

Preferably, the application forms part of an online multiplayer game.

More preferably, the application forms part of a gambling application.

Preferably, the application is in the form of a client application and the network connection means is adapted to connect the application to a similar server networking application.

According to another aspect of the invention, there is provided a server for hosting an online multi-user application, said application comprising a networking application as herein described.

According to another aspect of the invention, there is provided a method for connecting a mobile device to a remote device, the method comprising establishing a first socket-based network connection between the mobile device and the remote device, and establishing at least a second independent socket-based network connection with the remote device.

Preferably, the second network connection is established after the first connection has been established.

Preferably, the method further comprises detecting a communication disruption on at least one of the network connections, and establishing a new network connection via one of the network connections in the event that a communication disruption is detected on the other of the network connections.

According to yet a further aspect of the invention there is provided a mobile device incorporating an application as herein described.

According to a yet further aspect of the invention there is provided a networking system for a mobile communication device, which comprises a plurality of communication protocols for establishing a connection with a remote device, and means for establishing such connection using at least one of said protocols. By establishing such connection using at least one of said protocols, connection reliability may be improved.

According to a further aspect of the invention there is provided a networking system for a mobile communication device, comprising: means for establishing a connection with a remote device using any of a plurality of communication protocols; means for receiving a request to establish a further connection from said remote device; and wherein said connection establishment means is configured to establish said further connection using at least one of said plurality of communication protocols in response to receipt of said request.

According to a further aspect of the invention there is provided a networking system for a mobile communication device, said system comprising: means for establishing a connection with a remote device using any of a plurality of communication protocols; means for selecting a communication protocol from said plurality of communications protocols for use in attempting establishment of said connection; wherein each of said plurality of communications protocols have a pre-determined priority, and wherein said selection means is configured to select a first of said protocols according to its priority.

Preferably, the system further comprises means for selecting a first one of said communication protocols in dependence on a pre-determined priority. By selecting the communication protocol in dependence on a priority the most efficient protocol may be used.

Preferably said connection is a socket-based network connection. Said system may be located within said mobile communication device. Said system may be located both within said mobile communication device and said remote device.

Preferably, the system further comprises means for selecting a further one of said protocols when a connection using said first protocol fails to be established.

Preferably, said selection means selects a further one of said protocols until a connection is established, or there are no further such protocols available.

Preferably, the system further comprises means for selecting a first one of said communication protocols in dependence on a pre-determined priority.

Preferably, said selection means is configured for selecting a further one of said protocols, in dependence on said priority, when a connection using said first protocol fails to be established.

Preferably, said selection means is configured for iterative selection of further protocols, in dependence on priority, until a connection is established, or there are no further such protocols available.

The system may further comprise means for sensing at least one condition. The priority may be predetermined in dependence on the or each condition. The, each, or at least one condition is preferably internal to said system. The, each, or at least one internal condition is predetermined in dependence on a condition of said mobile communication device.

Said mobile communication device condition preferably comprises at least one of: type of mobile communication device, firmware version, battery level, signal level, and geographic location. The or at least one condition may be external to said system and/or may comprise at least one of: the network provider, the gateway, the time of day, and the day of the week.

The system may comprise memory for recording details of each connection session.

The priority may be predetermined in dependence on at least one previous session. The system may comprise means for changing said priority. The priority may be changed such that the communication protocol used for a successful connection is made top priority. Preferably, said means for changing said priority is dependent on the or each condition. The system may further comprise means for changing the priority manually.

Preferably, said means for changing said priority is configured to change said priority dependent on the, each, or at least one condition.

Preferably, a plurality of said connections are established. Each of said plurality of connections may use the same type of communication protocol or may use a different type of communication protocol. Each of said plurality of communication protocols may be of a different type. At least one type may be configured to establish a duplex connection. At least one type may require a communication handshake. At least one type may require packets of data to be given a sequence number. At least one type may require acknowledgement that data has been received. At least one type may use the Transmission Control Protocol (TCP). At least one type may use two independent socket-based connections. At least one type may use the User Datagram Protocol (UDP). At least one said type may use the Hypertext Transfer Protocol (HTTP).

Preferably, said connection establishment means is configured for establishing a plurality of said connections.

Preferably, each said independent connection is configured to be a simplex connection.

Preferably, said request is initiated manually within the remote device.

Preferably said independent connection is configured for writing data to a remote application to which the application is connectable, and preferably to configure the second network connection to read data from a remote application to which the application is connectable.

Preferably the system comprises means for receiving a request to establish a further connection from said remote device; wherein said connection establishing means is preferably configured for establishing said further connection preferably using at least one of said plurality of communication protocols on receipt of said request.

Said further such connection may use a different communication protocol to said connection. Said further connection may use one of Transmission Control Protocol, dual connection Transmission Control Protocol, User Datagram Protocol and Hypertext Transfer Protocol. Said further connection may be established without disrupting the communications between said mobile device and said remote device.

According to a yet further aspect of the invention there is provided a networking system for a mobile communication device, comprising: a plurality of communication protocols for establishing a connection with a remote device; means for establishing a connection with a remote device using at least one of said plurality of communication protocols; and means for establishing a further such connection using a further one of said plurality of communication protocols. By providing a means for establishing a further such connection, communications between the mobile telecommunications device and the remote device may continue without disruption.

According to a yet further aspect of the invention there is provided a networking system for a mobile communication device, comprising: a plurality of communication protocols for establishing a connection with a remote device; means for establishing a connection with a remote device; means for determining when said connection has been disrupted; and a timer; wherein said timer is used to time the period between sending data and receiving an acknowledgement that said data has arrived. By providing a timer the time taken to detect a disrupted connection may be reduced.

According to a further aspect of the invention there is provided a networking system for a mobile communication device, comprising: means for establishing a connection with a remote device using any of a plurality of communication protocols; and means for determining when an established connection has been disrupted, said determining means comprising a timer; wherein said timer is configured to time a period between sending data and receiving an acknowledgement that said data has arrived.

Preferably, said determining means determines said established connection to have been disrupted when said period reaches or exceeds a pre-determined time.

Preferably, said determining means is configured to initiate establishment of a further connection by said connection means, on determination that an existing established connection has been disrupted.

Said connection preferably uses a communication protocol with an in-built timer. Said timer may be used in conjunction with said in-built timer. Said timer and said in-built timer may operate independently. Said timer and said in-built timer may operate on separate threads.

Preferably, said time period is sufficient to allow said protocol's in-built timer to attempt at least one re-connection, preferably two, three or four connections, preferably less than 10 or 5 connections.

Preferably, said time period is sufficient to allow said in-built timer to initiate data resend at least once, preferably twice, three or four times, preferably less than 10 times or 5 times. Said time period may be between 10 and 40, preferably between 15 and 25, more preferably between 18 and 22 seconds. Said connection may use the TCP communication protocol.

Said remote device may be a server.

According to a further aspect of the invention there is provided a networking application for use as part of a multi-user application and suitable for a mobile communication device, the networking application forming part of a networking system of any preceding claim and comprising: means for identifying a desired communication protocol; means for configuring the device to communicate using the desired communication protocol; wherein said connection means is configured for establishing a network connection between said networking application and a related remote networking application using the desired protocol, whereby communication in accordance with the desired communication protocol enhances the operation of the multi-user application relative to use of at least one further communication protocol.

According to a further aspect of the present invention there is provided a networking application for a mobile communication device, the device being capable of communicating in accordance with a plurality of communication protocols, said application comprising means for identifying a desired communication protocol, means for configuring the device to communicate using the desired communication protocol, and means for establishing a network connection using the desired protocol, whereby communication in accordance with the desired communication protocol enhances the operation of the application.

According to a further aspect of the present invention there is provided a networking application for use as part of a multi-user application and suitable for a mobile communication device, the device being capable of communicating in accordance with a plurality of communication protocols, said application comprising: means for identifying a desired communication protocol; means for configuring the device to communicate using the desired communication protocol; and means for establishing a network connection between said networking application and a related remote networking application using the desired protocol, whereby communication in accordance with the desired communication protocol enhances the operation of the multi-user application relative to use of at least one further communication protocol.

Preferably, the further communication protocol is a higher level protocol than the desired communication protocol.

Preferably, the further communication protocol includes a layer of a protocol stack not present in said desired protocol.

Preferably, said multi-user application is configured to allow a plurality of users to interact while using of said multi-user application.

Preferably, said multi-user application is configured to allow each of a plurality of users to use said multi-user application independently of each other user.

Preferably, the multi-user application is a multi-player game.

Preferably, the multi-player game is configured to allow a plurality of players to play against one another.

Preferably, the multi-player game is configured to allow a plurality of players to play independently of one another.

Preferably, the further communication protocol includes a layer of the protocol stack of the ISO Open

System Interconnect (ISO/OSI) networking communications model not present in said desired protocol.

According to a further aspect of the present invention there is provided a networking application for a mobile communication device, the device being capable of communicating in accordance with a plurality of communication protocols, said application comprising means for identifying a desired communication protocol, means for configuring the device to communicate using the desired communication protocol and a further communications protocol, and means for establishing a network connection using the desired communication protocol and at least one further network communications protocol.

According to a further aspect of the present invention there is provided a networking application for use as part of a multi-user application and suitable for a mobile communication device, said application comprising means for identifying a desired communication protocol, means for configuring the device to communicate using any of a plurality of communication protocols, the plurality of protocols comprising the desired communication protocol and a further communications protocol, and means for establishing a network connection between said networking application and a related remote networking application using the any of said plurality of communication protocols.

Preferably, the further communication protocol includes a layer of a protocol stack not present in said desired protocol.

Preferably, the further communication protocol includes a layer of the protocol stack of the ISO Open System Interconnect (ISO/OSI) networking communications model not present in said desired protocol.

Preferably, the application further comprises means for transmitting a request for information relating to a network connection setting of the device, and means for receiving information relating to a network connection setting, wherein the configuration means is further adapted to configure the device in dependence on the received information.

According to a further aspect of the invention there is provided a networking application for a mobile communication device, the device being capable of communicating in accordance with a plurality of communication protocols, said application comprising means for identifying a desired communication protocol, means for transmitting a request for information relating to a network connection setting of the device, means for receiving information relating to a network connection setting, configuration means for configuring the device to communicate in dependence on the received information, and means for establishing a network connection.

Preferably, the application further comprises: means for transmitting a request for information relating to a network connection setting of the device for the desired protocol; and means for receiving the requested information, wherein the configuration means is further adapted to configure a connection setting of the device for the desired protocol in dependence on the received information; and wherein said connection means is adapted to establish said connection based on said settings.

According to a further aspect of the invention there is provided a networking application for a mobile communication device, the device being capable of communicating in accordance with a plurality of communication protocols, said application comprising: means for identifying a desired communication protocol; means for transmitting a request for information relating to a network connection setting of the device for the desired protocol; means for receiving the requested information; configuration means for configuring a connection setting of the device for the desired protocol in dependence on the received information; and means for establishing a network connection based on said setting.

Preferably, the configuration means is adapted to configure the device to communicate in accordance with a particular communications protocol in dependence on the received information.

Preferably, the configuration means is adapted to configure the device to communicate in accordance with the desired protocol in dependence on the received information.

Preferably, the further communications protocol is a higher level communications protocol than the desired protocol.

Preferably, the further communication protocol includes a layer of a protocol stack not present in said desired protocol.

Preferably, the further communication protocol includes a layer of the protocol stack of the ISO Open System Interconnect (ISO/OSI) networking communications model not present in said desired protocol.

According to a further aspect of the invention there is provided a networking application for a mobile communication device, the device being capable of communicating in accordance with a plurality of communication protocols, said application comprising means for identifying a desired communication protocol, means for transmitting a request for information relating to a network connection setting of the device in the form of a message via a messaging application, means for receiving information including a network connection setting, configuration means for configuring the device to communicate in dependence on the received information, and means for establishing a network connection.

According to a further aspect of the invention there is provided a networking application for a mobile communication device, the device being capable of communicating in accordance with a plurality of communication protocols, said application comprising: means for identifying a desired communication protocol; means for transmitting a request for information relating to a network connection setting of the device for the desired protocol in the form of a message via a messaging application; means for receiving information including a network connection setting; configuration means for configuring a connection setting of the device for the desired protocol thereby to allow communication in dependence on the received information; and means for establishing a network connection based on said setting.

Preferably, said request comprises details relating to said mobile communication device and/or an existing network connection setting thereby to assist a remote application to determine an appropriate network connection setting from a plurality of possible connection settings.

Preferably, the networking application network connection means is adapted to establish a further socket-based network connection.

According to a further aspect of the present invention there is provided a networking application for a mobile communication device, which comprises means for establishing a first socket-based network connection with a remote device, and wherein the network connection means is adapted to establish at least a second independent socket-based network connection with the device.

Preferably, the networking application network connection means is adapted to establish a further socket-based network connection with said related networking application.

According to a further aspect of the present invention there is provided a networking application for use as part of a multi-user application and suitable for a mobile communication device, which comprises: means for establishing a first socket-based network connection with a related networking application of said multi-user application on a remote device; wherein the network connection means is adapted to establish at least a second independent socket-based network connection with said related networking application of said multi-user application on the remote device.

Preferably, said connections are configured to allow transfer of application data of the multi-user application between said networking applications.

According to a further aspect of the present invention there is provided a networking application for a mobile communication device, which comprises means for establishing first and second socket-based network connections with a remote device, means for detecting a communication disruption on at least one of the network connections, and wherein the network connection means is adapted to establish a new network connection via one of the network connections in the event that a communication disruption is detected on the other of the network connections.

According to a further aspect of the present invention there is provided a networking application for use as part of a multi-user application and suitable for a mobile communication device, which comprises: means for establishing first and second socket-based network connections with a related networking application of the multi-user application on a remote device; and means for detecting a communication disruption on at least one of the network connections; wherein the network connection means is adapted to establish a new network connection via one of the network connections in the event that a communication disruption is detected on the other of the network connections.

Preferably, the application forms part of a multi-user application.

Preferably, the multi-user application forms part of a casino type application (for example, a poker, a roulette and/or a black-jack application) and/or a virtual sport application (for example virtual horse racing).

According to a further aspect of the invention there is provided an apparatus for hosting a networking application which is accessible by at least one mobile device, wherein the networking application is accessible by a related networking application as described herein.

According to a further aspect of the invention there is provided an apparatus for hosting a networking application which is accessible by at least one mobile device, wherein the networking application forms part of a networking system as described herein.

Preferably, the apparatus comprises: means for connecting the apparatus to a communications network to which the mobile device is connectable; means for receiving a request from the mobile device for information relating to at least one network connection setting for connecting the mobile device to the application based on a desired protocol; and means for transmitting the information including the network connection setting to the mobile device.

According to a further aspect of the invention there is provided an apparatus for hosting a networking application which is accessible by at least one mobile device, the apparatus comprising means for connecting the apparatus to a communications network to which the mobile device is connectable, means for receiving a request from the mobile device for information relating to at least one network connection setting for connecting the mobile device to the application, and means for transmitting the network connection setting to the mobile device.

According to a further aspect of the invention there is provided an apparatus for hosting a networking application which is accessible by at least one mobile device, the apparatus comprising: means for connecting the apparatus to a communications network to which the mobile device is connectable; means for receiving a request from the mobile device for information relating to at least one network connection setting for connecting the mobile device to the application based on a desired protocol; and means for transmitting the information including the network connection setting to the mobile device.

According to a further aspect of the invention there is provided an apparatus for hosting a networking application which is accessible by at least one mobile device, the apparatus comprising: means for connecting the apparatus to a communications network to which the mobile device is connectable; wherein the apparatus comprises means for storing at least one application for download by mobile devices; and means for tagging a downloadable application in response to a download request from a mobile device prior to processing the download request.

According to a further aspect of the invention there is provided a mobile device incorporating a networking system as herein described.

According to a further aspect of the invention there is provided a server for hosting a networking system as herein described.

According to a further aspect of the present invention there is provided a method for connecting a mobile device to a server, thereby to enable a application to be executed on the mobile device and the server, the method comprising identifying a desired communication protocol, configuring the device to communicate using the desired communication protocol, and establishing a network connection using the desired protocol between the mobile device and the server, whereby communication in accordance with the desired communication protocol enhances the operation of the application.

According to a further aspect of the present invention there is provided a method for connecting a mobile device to a server, thereby to enable a multi-user application to be executed on the mobile device and the server, the method comprising: identifying a desired communication protocol; configuring the device to communicate using the desired communication protocol; and establishing a network connection using the desired protocol between a networking application on the mobile device and a related networking application on the server, whereby communication in accordance with the desired communication protocol enhances the operation of the multi-user application relative to use of at least one further communication protocol.

According to a further aspect of the present invention there is provided a method for connecting a mobile device to a server, thereby to enable a multi-user application to be executed on the mobile device and the server, the method comprising: identifying a desired communication protocol; configuring the device to communicate using the desired communication protocol; establishing a network connection using the desired protocol between a networking application on the mobile device and a related networking application on the server; and establishing a network connection between said networking applications using at least one further network communications protocol in the event that it is not possible to establish a network connection using the desired communication protocol.

Preferably, the method further comprises transmitting a request for information relating to a network connection setting of the device, receiving information relating to a network connection setting, and configuring the device in dependence on the received information.

Preferably, the method further comprises transmitting a request for information relating to a network connection setting of the device for the desired protocol, receiving information relating to a network connection setting, and configuring a connection setting of the device for the desired protocol in dependence on the received information.

According to a further aspect of the present invention there is provided a method for connecting a mobile device to a server, thereby to enable a multi-user application to be executed on the mobile device and the server, the method comprising: identifying a desired communication protocol; configuring the device to communicate using the desired communication protocol; transmitting a request for information relating to a network connection setting of the device for the desired; receiving the information relating to a network connection setting; configuring a connection setting of the device for the desired protocol in dependence on the received information; and establishing a network connection using the desired protocol between a networking application on the mobile device and a related networking application on the server.

Preferably, the request is in the form of a message transmitted via a messaging application.

Preferably, the request is transmitted over an existing network connection based on a further communications protocol.

Preferably, the further communication protocol is a higher level protocol than the desired communication protocol.

Preferably, the further communication protocol includes a layer of a protocol stack not present in said desired protocol.

Preferably, the further communication protocol includes a layer of the protocol stack of the ISO Open System Interconnect (ISO/OSI) networking communications model not present in said desired protocol.

Preferably, the method further comprises establishing a first socket-based network connection between the networking application on the mobile device and the networking application on the server, and establishing at least a second independent socket-based network connection with the server.

According to a further aspect of the present invention there is provided a method for connecting a mobile device to a remote device, the method comprising establishing a first socket-based network connection between the mobile device and the remote device, and establishing at least a second independent socket-based network connection with the remote device.

According to a further aspect of the present invention there is provided a method for connecting a mobile device to a remote device thereby to enable a multi-user application to be executed on the mobile device and the remote device, the method comprising establishing a first socket-based network connection between a networking application on the mobile device and a related networking application on the remote device, and establishing at least a second independent socket-based network connection with the related networking application on the remote device.

According to a further aspect of the present invention there is provided a method for connecting a mobile device to a remote device thereby to enable a multi-user application to be executed on the mobile device and the remote device, the method comprising establishing first and second socket-based network connections between a networking application on the mobile device and a related networking application on the remote device; detecting a communication disruption on at least one of the network connections; and establishing a new network connection via one of the network connections in the event that a communication disruption is detected on the other of the network connections.

Preferably, said connections are configured to allow transfer of application data thereby to allow operation of said multi-user application.

According to a further aspect of the present invention there is provided a method for attempting connection of a mobile device to a remote device comprising: selecting a communication protocol from a plurality of communications protocols in dependence on a pre-determined priority; attempting to establish said connection between the mobile device using the selected protocol.

Preferably, said selection means is configured to iteratively select a further one of said protocols in priority order, until a connection is established, or there are no further protocols available.

According to a further aspect of the present invention there is provided a method for connecting a mobile device to a remote device comprising: establishing a connection with the device using at least one of a plurality of communication protocols; receiving a request to establish a further connection from said remote device; and establishing a further connection using at least one of said plurality of communication protocols on receipt of said request.

Preferably, said request is initiated manually within the remote device.

Preferably, said further such connection uses a different communication protocol to said connection.

Preferably, said further connection uses one of Transmission Control Protocol, dual connection Transmission Control Protocol, User Datagram Protocol and Hypertext Transfer Protocol.

Preferably, said further connection is established without disrupting the communications between said mobile device and said remote device.

According to a further aspect of the present invention there is provided a method for initiating reconnection between a mobile device to a remote device comprising: establishing a connection with the remote device using any of a plurality of communication protocols; timing a period between sending data and receiving an acknowledgement that said data has arrived; determining the established connection to have been disrupted when the period exceeds or reaches a pre-determined time; and initiating establishment of a further connection on determination that said established connection has been disrupted.

According to a further aspect of the present invention there is provided a method as herein described, wherein the mobile device incorporates an application as herein described, and wherein the server/remote device comprises an apparatus as herein described.

By dynamically switching between protocols, while the application is in operation, dependent on the real-time performance of the protocol the present invention solves the problem of under-performing transfer protocols by switching to an alternative. Preferably, the invention allows switching between four individual protocols; HTTP, TCP duplex, TCP dual, and UDP. Preferably, the system can react in real time to changing network conditions which may provide the user with an optimal connection at all times.

Preferably, the protocols may be switched dependent on a number of factors. Preferably, a look-up table is provided to enable the most suitable protocol to be used depending on the various parameters.

According to another aspect of the invention, there is provided a communications system which comprises a communications network, a server as herein described connectable to the communications network, and a mobile device as herein described connectable to the communications network.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa. More particularly aspects of the invention extend to methods carried out by any of the above aspects including the apparatus, system, and application aspects.

Several aspects of the present invention are disclosed in the independent claims. Preferable features are recited in the attached dependent claims.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which: —

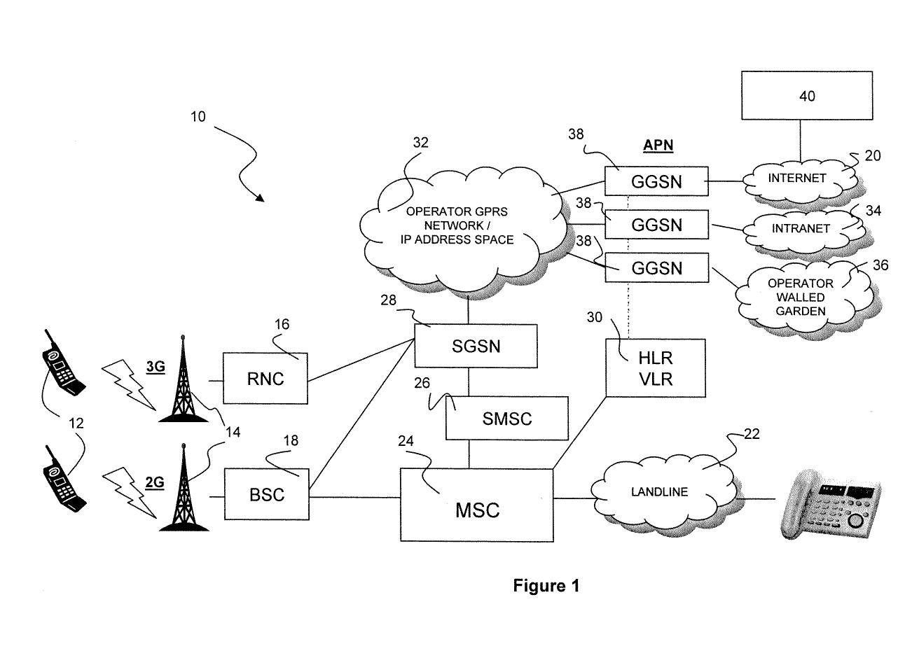

FIG. 1 illustrates a first communication network to which a mobile device and a server are connectable;

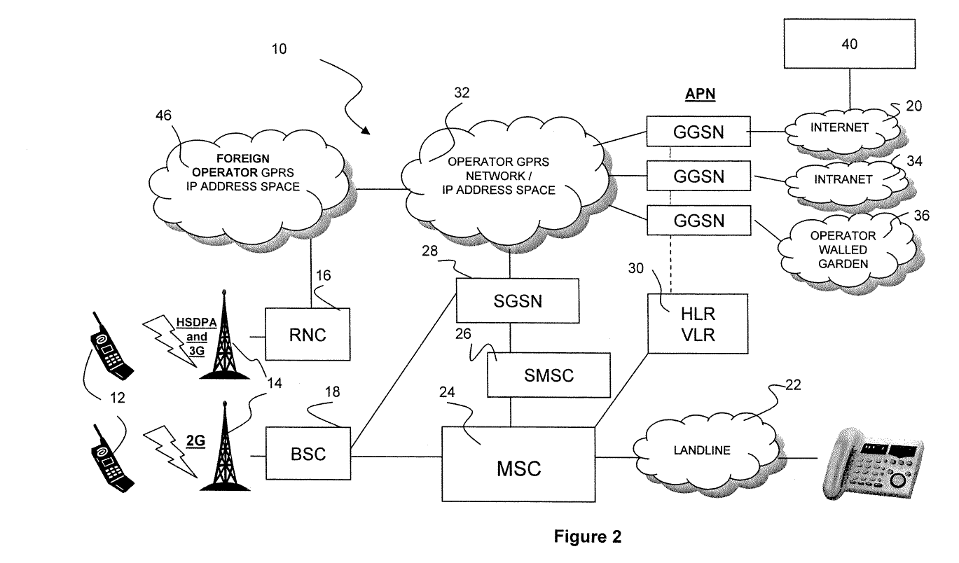

FIG. 2 illustrates another communication network to which a mobile device and a server are connectable;

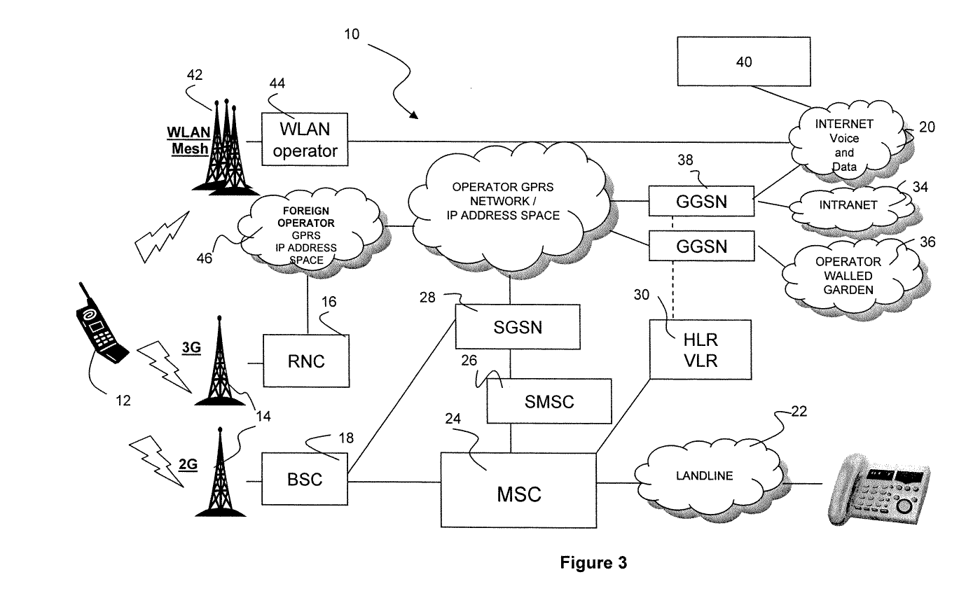

FIG. 3 illustrates a further communication network to which a mobile device and a server are connectable;

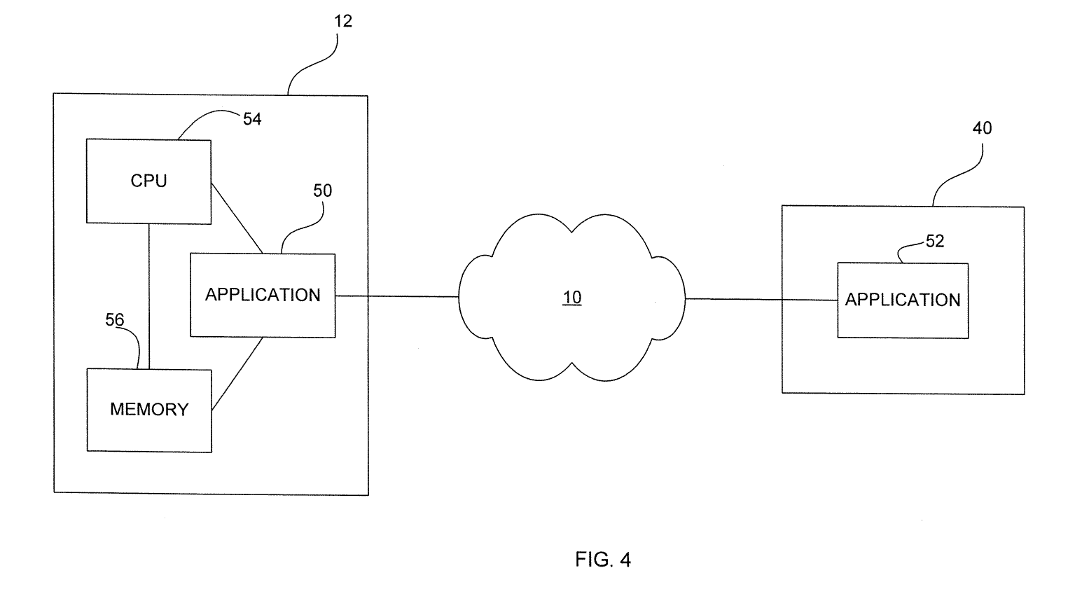

FIG. 4 illustrates a mobile device connected to a server via a communications network;

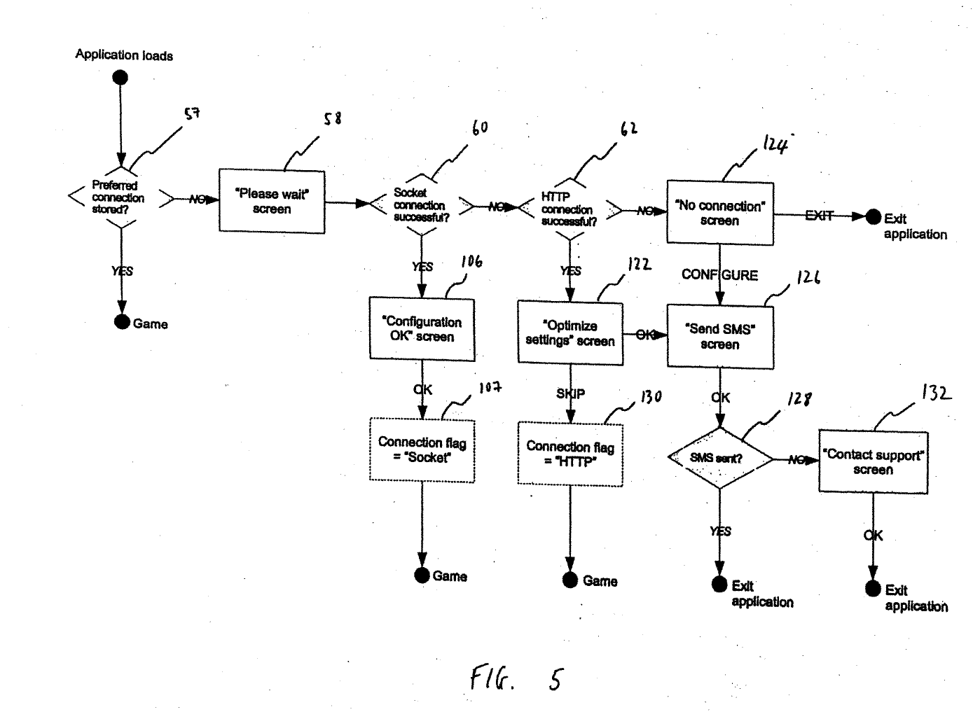

FIG. 5 is a flow diagram which describes, in overview, the operation of a networking application running on a mobile device;

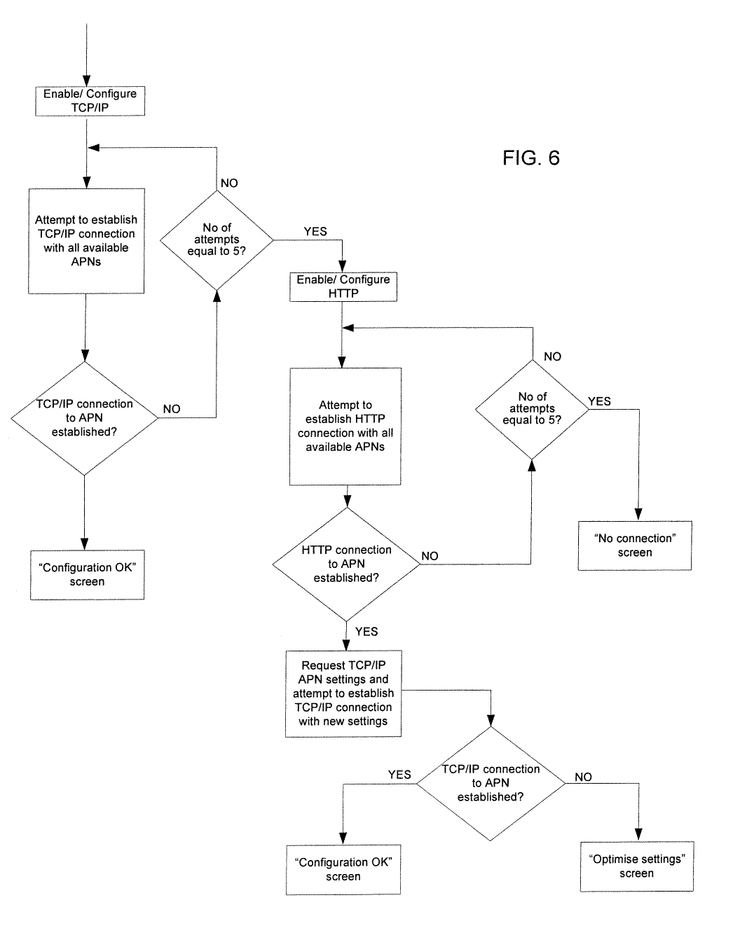

FIG. 6 is a more detailed flow diagram of a portion of the flow diagram shown in FIG. 5;

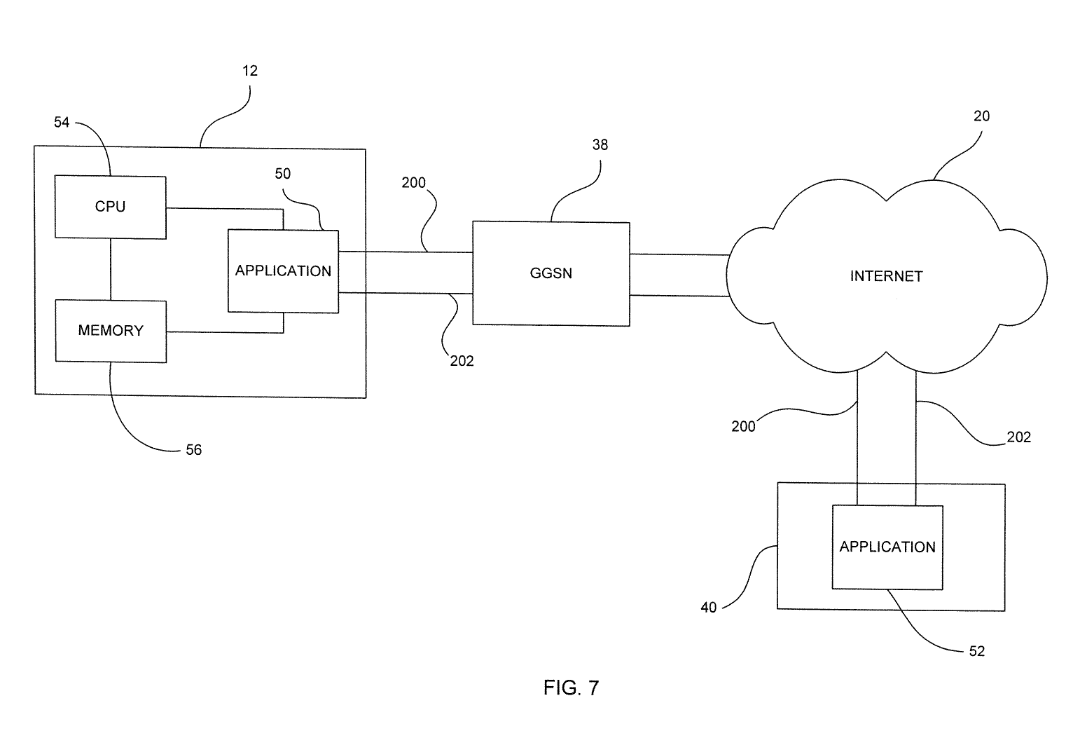

FIG. 7 illustrates a mobile device connected to a server via a gateway and the internet;

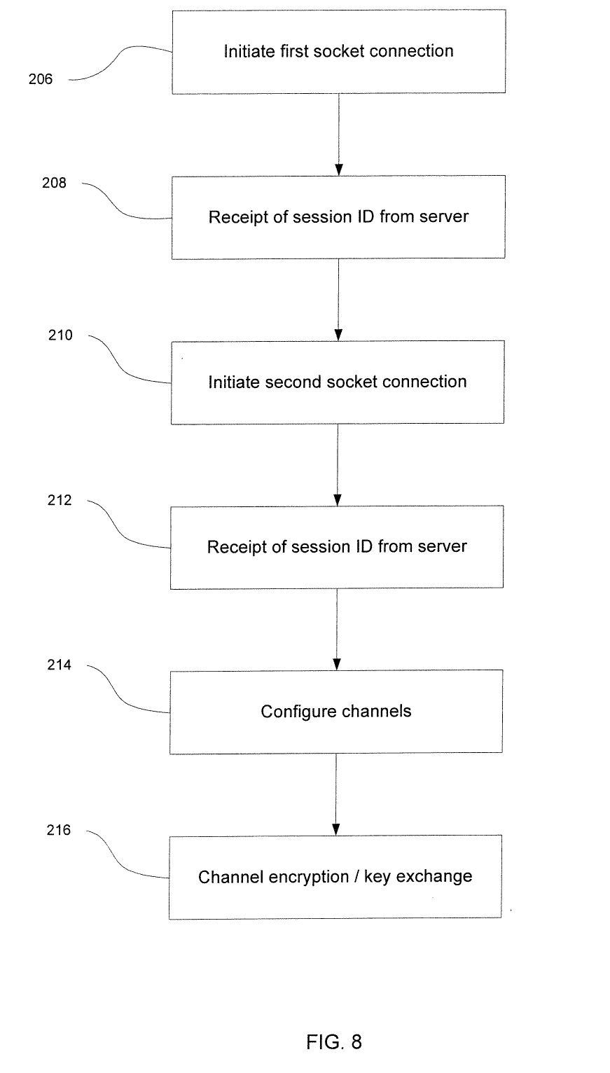

FIG. 8 is a flow diagram which describes further aspects of the operation of the networking application;

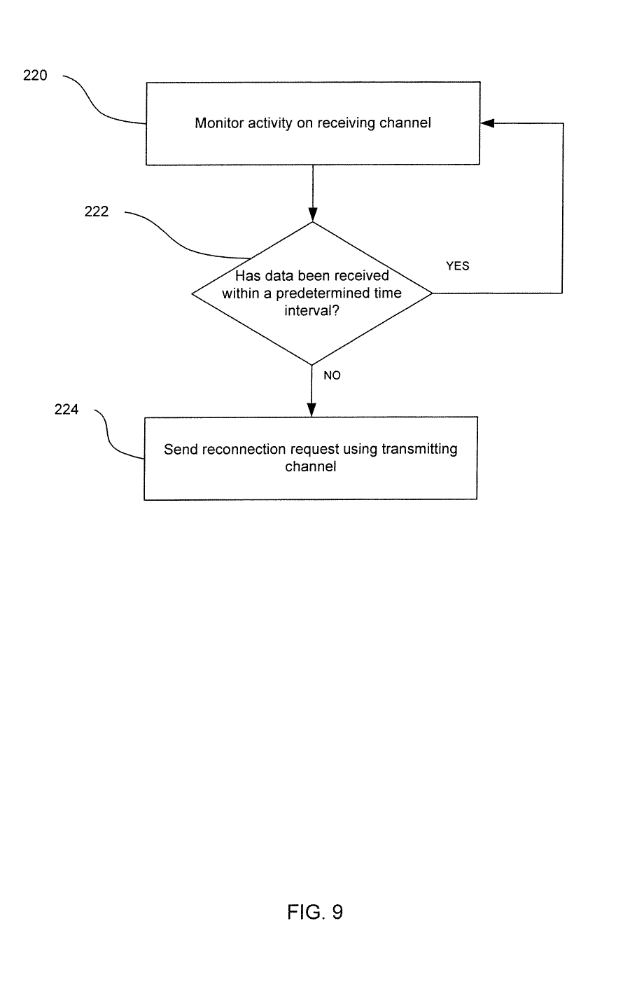

FIG. 9 is a flow diagram which describes yet further aspects of the operation of the networking application;

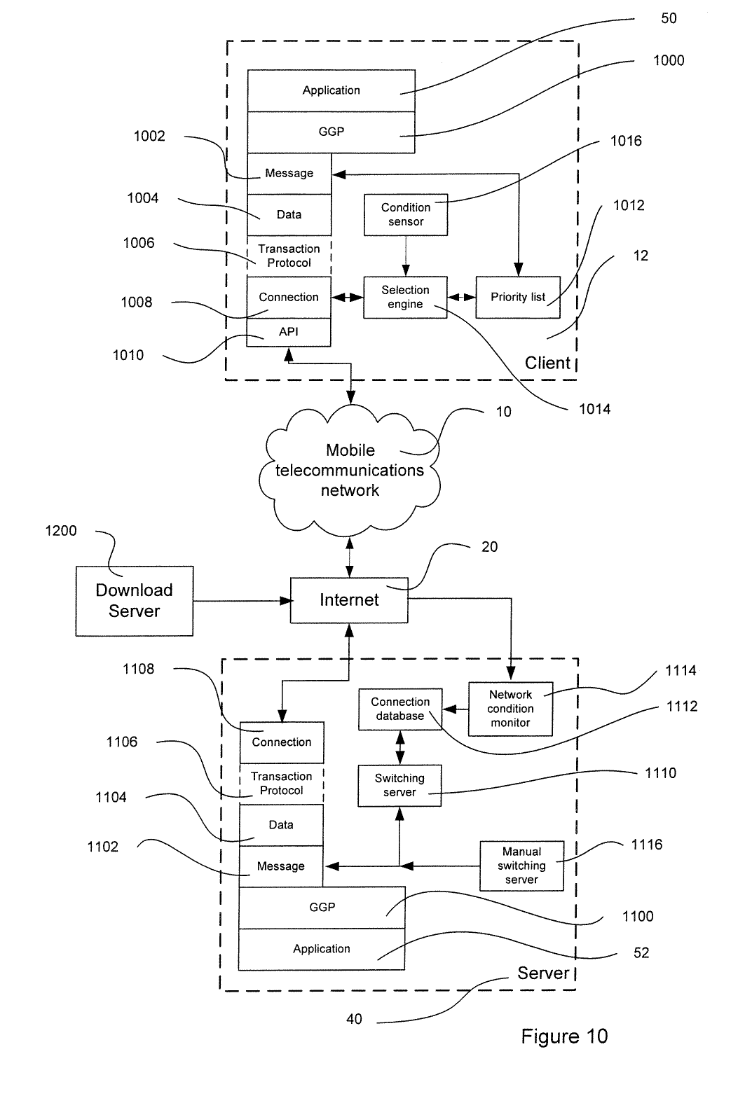

FIG. 10 shows a schematic diagram of the client and server systems;

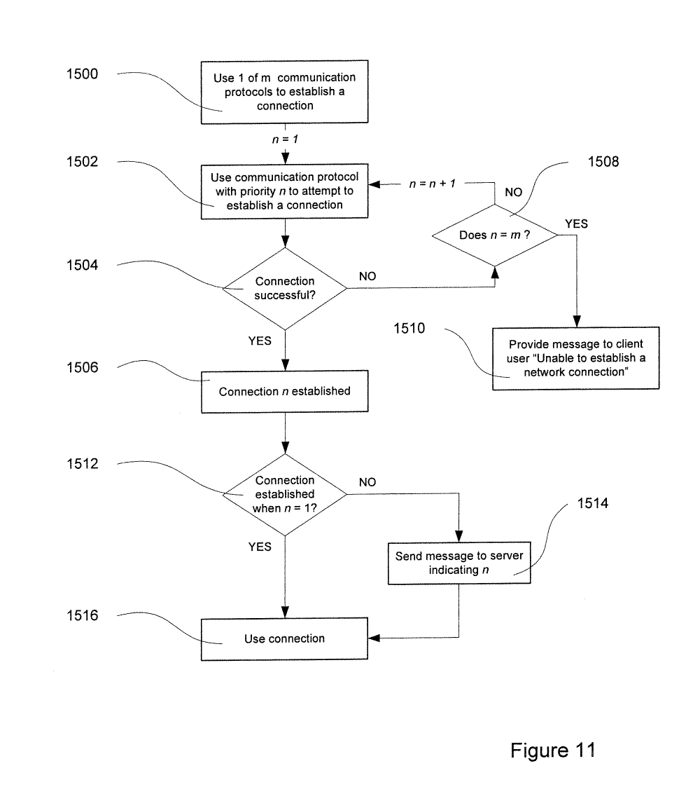

FIG. 11 shows a flow diagram of a connection process;

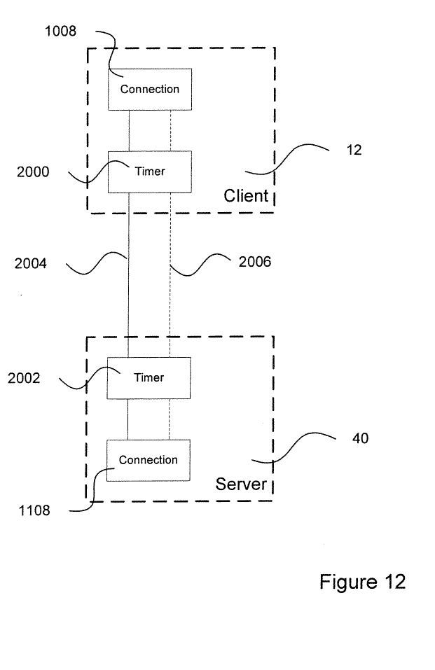

FIG. 12 shows a schematic diagram of the timer feature; and

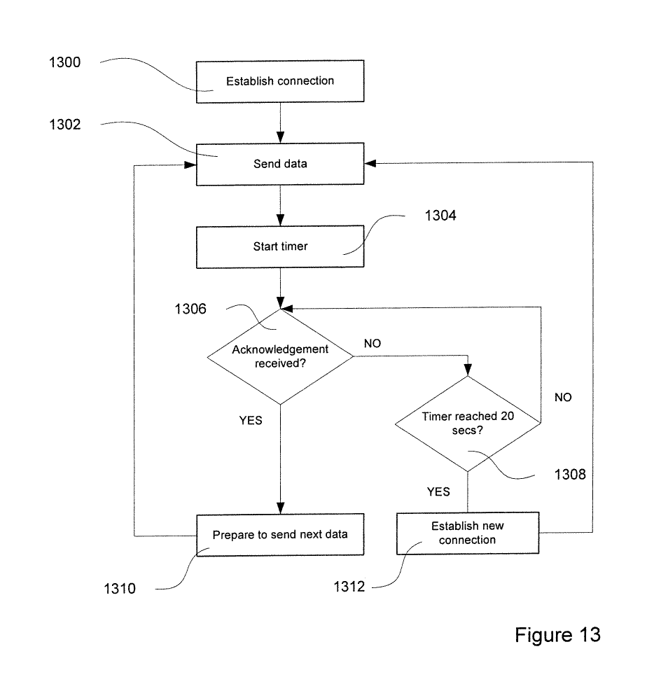

FIG. 13 shows a flow diagram of a timeout feature.

### NETWORKING INFRASTRUCTURE ASPECTS

In FIG. 1 a communications network in the form of a mobile telecommunications network 10 is shown. This network 10 is connected to a variety of further communications networks such as the Internet 20 and a PSTN network 22. A number of mobile devices 12 are also connectable to the network 10. The mobile devices 12 may be in the form of cellular telephone handsets, personal digital assistants, portable gaming devices, or the like, and are connectable to the network 10 using either a 2G or 3G connection via cellular antennas 14, which are in turn connected to the network 10 via either a BSC 18 (Base Station Controller) or a RNC 16 (Radio Node Controller). The network 10 also comprises a MSC (Main Switching Centre) 24, an SMSC (Short Message Service Centre) 26, a SGSN (Serving GPRS Support Node) 28 and a HLR/VLR (Home Location Register/Visitor Location Register) 30. The SGSN 28 provides a connection to the mobile network operator GPRS network (IP address space) 32 which is connected to the internet 20, a private company intranet 34 or a network operator “walled garden” 36 via a number of GGSNs (Gateway GPRS Support Nodes) 38.

As shown in FIG. 4, each mobile device 12 runs a client networking application 50 which is, in use, connectable to an associated server networking application 52 running on a server 40 which is connectable to the internet 20. These networking applications 50, 52 form part of an online multiplayer gaming application (not shown), for example, an online poker game hosted on the server 40 and accessible to a plurality of mobile devices 12. As schematically shown in FIG. 4, and as will be described in further detail below, the networking application 50 is able to interact with the mobile device 12 processor 54 and memory 56 in order to configure the network connection settings of the mobile device 12.

The application 50 includes a network configuration means in the form of a network configuration module which is adapted to perform communications settings testing and configuration. The application 50 also includes a network connection means in the form of a network connection module which establishes the network connection between the application 50 and the application 52 via an APN gateway.

The application 52 running on the server 40 includes an SMS server which is able to transmit network configuration messages in response to requests for network settings received from mobile devices 12. Such requests are generated by the applications 50 running on each mobile device 12. In one example, the server 40 also acts as a download portal for the online game. Thus, mobile devices 12 may access the server 40 in order to download the game.

FIGS. 2 and 3 show similar networks 10 to that shown in FIG. 1, and accordingly like reference numerals have been used to indicate like networking components. The network 10 shown in FIG. 2 additionally incorporates a foreign operator address space 46, and the network 10 shown in FIG. 3 incorporates a WLAN (Wireless Local Area Network) mesh 42 which is connected to a WLAN operator 44 which is in turn connected directly to the Internet 20. In the network 10 shown in FIG. 3, the mobile device 12 is capable of connecting via 2G or 3G to the network 10, and via the WLAN mesh 42. It will be appreciated that it is also possible to connect to the network 10 via the so-called 2.5 G communications standard, or via a variety of other communication standards or protocols.

In an example, a packet-based communication architecture such as (General Packet Radio Service) GPRS is employed to enable the mobile devices 12 to connect to the internet 20. The mobile devices 12 are then in turn able to connect to the server 40.

In particular, the mobile devices 12 use GPRS or other packet-based wireless technologies to connect to a mobile operator GPRS network 32 via the SGSN 28. The operator GPRS network is a LAN-like network with an address space that is controlled by the operator of the network 10. Each mobile device 12 is then able to address or communicate with an Access Point Name (APN), which is a computer with an IP address, located within the operator address space. In an example, a variety of APNs are located on each of the Gateway GPRS Support Nodes (GGSNs) 38.

When a mobile device 12 connects to an APN it is able to check the identity of the mobile device 12, for example, by checking the MS-ISDN (Mobile Station Integrated Services Digital Network) number of the mobile device 12 to determine whether or not the particular mobile device 12 is permitted to communicate with that APN.

Once the identity of the mobile device has been verified the mobile device 12 is permitted to communicate with the APN and the APN will then obtain a temporary IP address from the internet 20 for the mobile device 12. This enables the mobile device 12 to connect to the internet 20. Thus, a “communications channel” is effectively set up between the mobile device 12 and the APN.

Communications between the mobile device 12 and the APN, and hence between mobile device 12 and the internet 20, are handled using a particular communications protocol. The particular protocol employed by the mobile device 12 to connect to the internet 20 largely depends on the type of mobile device 12, and the network 10. In particular, in some examples a low level protocol based directly on TCP/IP (Transmission Control Protocol/Internet Protocol) is used. In other examples higher level protocols such as HTTP (Hyper Text Transfer Protocol) over TCP/IP or the mobile phone protocol WTP (Wireless Transaction Protocol), as used in WAP (Wireless Application Protocol) APN gateways, are used. A low level TCP/IP connection is often referred to as socket based connection.

The mobile device 12 also incorporates an operating system (not shown) such as Symbian™ Windows™ CE™ or a proprietary operating system provided by a phone manufacturer.

The mobile device 12 also runs various other software applications (not shown) which may also connect to the internet 20, for example, an e-mail application or internet web browser. Each of these applications will typically connect to an appropriate gateway or APN using a particular communications protocol. Accordingly, each mobile device 12 will have a number of stored network connection settings, each associated with a respective networking application provided on the device. By way of example, a particular mobile device 12 may use an HTTP APN as the default gateway for an e-mail application, a WAP WTP APN as a default gateway for internet browsing, a WAP WTP APN for a downloaded Java™ game, and a TCP/IP APN for a preinstalled Symbian™ calendar.

Thus, at the time that the gaming application is downloaded and installed onto a mobile device 12, the mobile device will typically not be configured to connect to the server 40. Indeed, it is likely that any networking configuration which has previously been carried out on the mobile device will complicate the processes of connecting to the gaming application to the server component of the application.

Furthermore, at the time the gaming application is downloaded and/or installed onto the device 12, the device 12 is unlikely to be configured to use the desired network connection which will optimise the operation of the game.

### Overview of the Networking Application

In use, a user of a mobile device 12 connects to the internet 20 using a preinstalled browser running on the mobile device 12, and browses the internet 20 via a WAP APN which is connected to various WAP sites provided by network 10 operator.

The user then connects to the server 40 and downloads and installs the gaming application onto the mobile device 12. If the user then attempts to connect to the server portion of the gaming application this is likely to be via a WAP APN connection to the internet 20. Such a connection employs an HTTP connection, and its associated service overheads, which increases delays and latency times experienced by the user playing the game, thereby diminishing the gaming experience. This is because the performance of an online game is enhanced if the playing table (in the case of an online poker game), which is displayed on the display screen of each player's mobile device 12, is refreshed as soon as a player performs an action such as folding or placing a bet.

Alternatively, when the user attempts to connect to the server 40, the user may fail to connect at all to the server due to the present network connection settings of the mobile device 12. Thus, if the user desires to play the game it will be necessary for him to manually reconfigure the mobile device to connect to the server 40. However, it is often difficult to reconfigure the network communication settings of a mobile device 12. Thus, an inexperienced user may not bother to go through the effort of setting up the mobile device 12 to access the server 40.

### The Networking Application

In overview, the networking application 50 which forms part of the downloaded game provides a configuration means in the form of network configuration module, which executes from within the application 50 and which automatically configures the device to connect to the corresponding networking application 52 located on the server 40 via a low level TCP/IP socket connection. This results in an improved connection to the server 40, which will enhance the operation of the game.

It will be appreciated that the connection between the applications 50, 52 is usually achieved via an APN (as described below), since the application 52 is executed on a server 40 connected to the internet and the application 50 is executed on a mobile device connected to a mobile communications network. Hence, in an example, the TCP/IP socket connection that is established is between the mobile device 12 and an APN.

With reference to the flow diagrams shown in FIGS. 5 and 6, when the gaming application first executes, the networking application 50 is executed. The networking application 50 then determines (using the network configuration module) whether or not the preferred or desired TCP/IP socket connection has been configured on the mobile device 12 (step 57). If it has been configured, the application 50 connects to the server portion of the networking application 52 running on the server 40 and the user is then able to play the online networked game over the desired socket connection.

### Connection Using the Desired Protocol

If the desired connection has not yet been configured on the device, the application 50 displays the “Please wait” screen 58, and then initially attempts to establish a (TCP) socket connection (step 60). If this fails the application 50 will attempt to establish an alternative (HTTP) network connection (step 62). The alternative connection can then be used to set up the desired network connection, or it can be used as a fall-back network connection over which the game may be played.

Steps 60 and 62 are illustrated in further detail in FIG. 6. As part of Step 60, the configuration module firstly enables TCP/IP communication on the mobile device 12 (step 100 in FIG. 6). This step may optionally involve configuring TCP/IP on the mobile device. At step 102 the configuration module scans through all available APN address settings stored on the mobile device 12 and attempts to establish a socket based TCP/IP connection, using a network connection module, with each APN stored on the device. In the event that the application is able to successfully connect (step 104) to one of these APNs using TCP/IP, and hence establishing a socket-based connection with the APN, the application displays the “Configuration OK” screen 106, and the user is then able to play the game using the desired network connection setting. The connection flag is also set to “Socket” (step 107 in FIG. 5).

As part of this above process the network connection module will automatically repeatedly attempt to connect to each APN at least five times (see step 108). Between each connection attempt the network connection module will wait an appropriate length of time. The appropriate length of time to wait prior to attempting to reconnect to each APN is based on the type of APN, for example, a TCP/IP APN will have a latency of around 1 second, and hence the network connection module will reattempt to establish a connection after waiting 2-3 seconds. For a WAP APN the latency is around 12 seconds and hence the network connection module will reattempt to connect after around 15-20 seconds.

### Connection Using an Alternative Protocol

If a connection cannot be established using TCP/IP (step 104), the configuration module attempts to establish an alternative network connection using an alternative protocol (step 62 in FIG. 5). In particular, as shown in FIG. 6, the configuration module enables HTTP on the mobile device 12 (step 110) and then attempts to connect to all APNs stored on the mobile device 12 using HTTP (step 112). As above, the configuration module will reattempt to connect to each APN five times (step 114).

If the network connection module is successfully able to establish an HTTP connection with one of the APN's (step 116) the application 50 connects to the application 52 running on the server 40 and then transmits a request (via a transmission means, in the form of a transmitting module) for the correct TCP/IP APN settings to enable the mobile device 12 to connect to the correct APN (step 118). In response to this request the server 40 then forwards the correct TCP/IP APN address details and settings to the mobile device 12. The configuration module then configures the mobile device 12 network settings in accordance with these details and then attempts to establish a TCP/IP connection to the correct APN.

If the attempt to connect to the APN over TCP/IP is successful (step 120), the application displays the “Configuration OK” screen 106 and the user is able to play the game over the desired socket-based connection. Alternatively, if the connection is unsuccessful, the application 50 displays the “Optimise Settings” screen 122.

The request for correct network settings may include information relating to the HTTP or WAP APN to which the device is presently connected. This will assist the server 40 in determining the appropriate network connection settings for the particular mobile device 12 and/or network 10 operator. The request may include details relating to the mobile device 12 itself, for example, the make and model, and/or the network operator. The user may also be prompted by the application 50 to enter information that will assist the server in determining the correct network settings.

Additionally, the request may include details relating to the mobile phone and/or the network operator which are extracted from a tag (or watermark) which has previously been applied to the networking application 50 or the downloaded game. In this case, at the time the mobile device 12 requests the download of the game the server 40 watermarks the game (or the networking application 50 portion of the game) with details relating the mobile device 12 and/or network operator. This information is then extracted by the application 50 and used when requesting the correct networking connection settings. The game may be tagged by inserting details of the mobile device 12 and/or details of the network operator into a Java™ application descriptor file or Java™ application resource file, which are may be compiled on the fly just prior to being downloaded. Thus, in the case where the application is in the form of a Java™ application, and hence in some cases unable to access the mobile device 12 settings from within the application, these settings can be obtained from the tag or watermark.

The server 40 includes a database which contains details of the appropriate APN settings for a variety of mobile devices and associated network operators. In an example this is in the form of a lookup table.

In the event that it is not possible to configure the correct TCP/IP settings via the HTTP connection the application displays the “Optimise settings” screen 122. In this case the application 50 will have an active HTTP connection to the server 40. Thus, it is possible to play the game via this connection, subject to the increased delays and latency associated with this less preferred network connection.

### Optimising the Network Connection

The “Optimise Settings” screen enables the user to select whether or not to attempt to establish the desired TCP/IP socket connection thereby to improve the performance of the game.

If the user chooses to optimise the network connection settings the configuration module attempts to obtain the correct network connection settings via SMS (Short Message Service) by sending an SMS message to the server 40 requesting the correct TCP/IP APN settings. This involves displaying the “Send SMS” screen 126 to the user, which enables the user to select whether or not to send an SMS message to the server 40 requesting the desired network connection settings.

As above, the SMS message may contain details relating to the mobile device 12 and/or existing network connection settings (including APN details stored on the device 12) to assist the server 40 in determining the correct network settings for the particular device 12 and network operator.

If the SMS message is successfully sent (step 128) the application exits and waits for the server to transmit an SMS message to the mobile device 12 with the correct network settings. In one example, the server 40 transmits two SMS messages to the device, the first containing the actual network connection settings (e.g. the TCP/IP APN address details) and the second containing user instructions as to how to input the settings into the particular mobile device 12. In another example, the server 40 transmits an Over-The-Air (OTA) configuration message to the mobile device 12. Upon receipt of this OTA message the mobile device 12 will be automatically configured with the new settings. In one example, as described in more detail below, the server end networking application 52 includes an SMS server module which handles the transmission of SMS configuration messages and OTA configuration messages to mobile devices 12.

When the user next accesses the application 50, it will then be possible for the application 50 to establish a TCP/IP socket based connection with an APN, which will enable the device 12 to access sever 40, and hence the server application 52 using the desired network connection.

If the SMS message is not sent, for example, if the user does not wish to incur the network operator charge of sending an SMS message, the application 50 displays a “Contact support” screen 132, which displays contact information relating to the provider of the game. The application 50 then exits.

If the user selects to skip the optimisation of the network connection, the connection flag is set to “HTTP” (step 130) and the user is then connected to the game.

In the event that no network connection can be established using HTTP or TCP/IP, the “No Connection” screen 124 is displayed by the application 50.

The configuration means then attempts to obtain the correct network connection settings via SMS (Short Message Service), by sending an SMS message to the server 40 requesting the correct TCP/IP APN settings as described above.

In another example (not shown) if a connection cannot be established using HTTP the configuration module enables a further communications protocol on the mobile device 12 and then attempts to connect to all APNs stored on the mobile device 12 using that further communications module.

### Further Aspects

The server 40 maintains a detailed log of all mobile devices 12 that request network connection settings from the server 40. These requests may be automatic requests generated by the networking application 50 as it attempts to configure the desired socket-based connection, or requests received via SMS for network connection settings. In an example, this log is maintained in a database stored on the server 40. In this case details relating to time at which the request was made are also stored along with the details of the request.

Using this information the server 40 is then able to generate a “customer care event”, which triggers the sending of a customer service message (via SMS) to the mobile device 12, if the server determines that the device 12 does not connect to the server 40 within a predetermined length of time. This message will ask the user if they require any further assistance in connecting to the server 40 and/or installing the game.

In this way the game provider is able to follow-up on the success users have in installing and connecting to the game, and may receive feedback from users regarding the process.

The customer care event may also result in a notification being sent to the game provider's call centre to contact the user to determine if the user requires any further assistance and/or to receive feedback from the user.

In an example, the server 40 networking application 52 is also able to monitor all incoming network connections and determine the type of each network connection setting. The application 52 is then able to automatically transmit the desired network connection settings to a mobile device 12 in the event that it detects that the mobile device 12 is not connected to the server 40 using the desired network connection.

In an example, the server 40 is further able to monitor requests for the download of the gaming application and generate a customer care event if the application is not subsequently downloaded within a predetermined time frame. The request for the download of content is in the form of an SMS message sent by the mobile device 12 to the server 40 requesting a link to the downloadable game. By way of example, a user may see an advertisement which prompts the user to send an SMS message to the server in order to receive a link to the game. The server 40 then sends a link to the requesting mobile device 12 via SMS. If the user is unable to connect to the internet, for example, then they will not be able to download the game in the first place. Thus, by monitoring such requests for downloads and then comparing such requests with actual downloads the server is able to identify users that have not been able to download the game.

The server 40 then transmits to the mobile device (via SMS) appropriate connection settings to enable the user to connect to the internet and then download the game.

The transmission of these settings themselves will also be logged, and if the user is still unable to download the game, for example, due to a content blocking firewall located within the network operator's network 10 the server 40 will transmit instructions to the mobile device 12 as to how to certify that the user of the device is indeed authorised to access the content provided on the server 40.

Further details relating to the networking application 50 are now provided with reference in particular to FIG. 5.

In an example, the networking application 50 may be incorporated or nested within a host gaming application. The application hence provides the gaming application with the ability to configure a mobile device 12 or handset on which the host application is installed and executed with the network settings required for an enhanced game experience.

The application 50 integrates with the host game application in the form of a class that is called on each host application launch and reports a next action following launch. The application 50 may either report an identified communications type (Socket or HTTP) that the host application can use or report that the game should exit (either because the user will receive configuration SMS messages shortly, or due to the lack of a working connection).

The application 50 consists of a communications testing part or configuration module, and a user interface part that guides a user through the possible options depending on the discovered communications functionality of the handset, and the SMS configuration, request preparation, and transmission.

In an example, the handset or device 12 is able to support MIDP 2.0 (Mobile Information Device Profile), with sockets support, and JSR-120 (Java™ Specification Requests) with WMA (Wireless Messaging API) 1.1 and SMS functionality.

### User Interface Aspects

Referring to FIG. 5, the operation or flow of the client networking application 50 user interface is now described.

The user interface guides a user through a number of configuration steps using the screens described below:

### Application Launch

During launch the application checks for the presence of an RMS (record management system) stored property indicating a preferred or desired network connection method.
If the property is found the application 50 reports this to the host application without checking whether it is actually functional.
If the property is not found the application 50 initiates configuration flow by displaying the “Please Wait” screen 58 and initiating a communications test using the configuration module.

### Please Wait Screen

The please wait screen 58 displays a notice to user while the communications test is being performed.

In an example, the message text is as follows: “Please wait while THE GAME verifies your internet connection settings for online play. This may take up to 60 seconds.”

### Communications Test

The communications test is performed by attempting to connect to a server hosting socket and HTTP “echoer” applications.

To control connection timeouts a limit of 30 (configurable) seconds per connection attempt is imposed so that total time for testing two connection methods (socket and HTTP) does not exceed 60 seconds.

In an example, the communications test is performed as follows: —
Attempt to connect to socket server
   If connection is successful
      Go to “Configuration OK” screen
      Store sockets as preferred connection method.
   If connection failed, continue
Attempt to connect to HTTP server
   If connection is successful go to “Optimize settings” screen.
   If connection failed go to “No connection” screen.

### Configuration OK Screen

This screen is displayed if the user has successfully connected to a socket connection.

In an example, the following message is displayed on the mobile device: “Your phone is configured for optimal game experience. Enjoy the game.”

The application 50 reports the fact that a socket connection to the host application has been set up and returns the user to the host application.

### Optimise Settings Screen

This is displayed if a socket connection is not available, but a working HTTP connection has been found. This screen invites the user to perform a network connections setting configuration, but also allows a user to skip this step and play the game using the existing HTTP connection. In this case the application will warn the user that this is not the preferred option.

In an example, the following message will be displayed in the mobile device 12: “Your phone is not configured for best game experience. To configure your phone for optimal game experience, please press “Ok”. Configuration takes up about 2 minutes and should ensure a lasting game experience. To proceed with current settings select “Skip”.”

Possible user actions:
User selects “OK”
   User is transferred to the “Send SMS” screen.
User selects “Skip”
   The HTTP setting is stored as the preferred connection and the user is returned the host gaming application.

### No Connection Screen

This screen is displayed if no working connections have been found, and explains to the user that an internet connection is necessary in order to play the game and offers to perform a phone configuration.

In an example, the following message is displayed: “No connection found. No working internet connection found. Please make sure that THE GAME is allowed to access Internet from your mobile phone and try again. If you would like to configure your phone please select “configure”.”

Possible user actions: —
User selects “Configure”
   User is transferred to the “Send SMS” screen to request configuration
User selects “Exit”
   The application exits

### Send SMS Screen

This screen is displayed prior to sending a configuration request SMS message. This screen explains to the user that an SMS will be sent and that the user should close the application once the message has been sent and await an incoming configuration message.

In an example, the following message will be displayed: “THE GAME will now send an SMS with a configuration request. If prompted, please accept. Once the request has been sent the application will exit to allow you to receive further instructions. The SMS will be charged in accordance with the standard rates of your network.”

Possible user actions: —
User selects “OK”
   The application attempts to send an SMS. If SMS is successfully sent the application will close. If the SMS sending fails, the application will display the “Contact support” screen.

### Contact Support Screen

This screen is displayed if the sending of a configuration request SMS fails. This screen suggests that the user contact customer support to resolve the problem.

In an example, the following message is displayed: “The application failed to send the SMS configuration request message. Please try again or visit our WAP site for configuration instructions.”

Possible user actions: —
User selects “OK”
   The application exists
User selects “WAP”
   The application exits and attempts to transfer the user to the predefined WAP site

### The SMS Server

The SMS server or module is provided as part of the application 52 on the server 40 and essentially matches incoming request strings from the application 50 running on the mobile phone with possible configuration messages to send out via SMS.

Upon receiving an incoming message the SMS server first parses the message to check whether or not it contains three tokens separated by a ‘:’. These are then matched against a set of property files described below.
1. In an example, an incoming message is processed in the following way:
2. Parse incoming message
3. Verify that user agent is present in devices.properties
4. Verify that SMSC is present in smscmappings.properties
5. Verify that device properties contains configuration for particular operator
6. Send information messages
7. Send configuration message

The SMS Server is implemented using a GSM modem for the transport layer. An ESME (External Short Messaging Entity) can also be used.

Incoming messages are formatted as follows: <user agent>:<SMSC number>:<version>

The user agent is extracted using the System.getProperty(“microedition.platform”) function. Alternatively, the user agent may be extracted using from the Java™ application descriptor (JAD) file.

The SMSC number is extracted using the System.getProperty (“wireless.messaging.sms.smsc”) function. As per the WMA 1.1 specification this property must include an active SMSC that allows the application 50 to map a request to a specific operator.

The application 50 also accesses a file containing a list of known SMSC numbers and corresponding operator strings for use when reading the device properties. This file is known as the smscmappings.properties file. The format of the file is as follows:

<smsc number>=<operator string>
+44123123=operator1
+44234234=operator2
+44887766=operator1

The application 52 also accesses a file containing a list of known user agents and corresponding device properties file name, known as the devices.properties file. An example of the format of this file is as follows:

<user agent>=<resource bundle name (excluding .properties)>
Nokia6280/03.60=nokia6280
NokiaN70=nokian70
Nokia6230i/03.30=nokia6230i

This file is read upon loading and all valid strings are read into memory. This file format also allows phones to be grouped with identical configurations into a single properties file.

A further file containing actual messages to send to the phone when a valid request has been received is also provided. This is known as the <devicename>.properties file. The format of this file is as follows:

message1=<first message to send>
message2=<second message to send>
message3=<third message to send>
settings.<operator string1>=<hex encoded binary message>
settings.<operator string1>.sourceport=<source port>
settings.<operator string1>.destinationport=<destination port>
settings.<operator string2>=<hex encoded binary message>
settings.<operator string2>.sourceport=<source port>
settings.<operator string2>.destinationport=<destination port>

Where: —
“Message1” to “Message3” include up to 3 messages to be sent to the user before sending the actual configuration message. This may include instructions on how to install settings or marketing messages;
“settings.<operator string>”: is a hexadecimal encoded binary message body containing WAP push headers and WBXML provisioning data; and
“settings.<operatorstring>.sourceport” and “settings.<operator string>.destinationport”: allows the delivery of both OMA CP 1.1 (ports: 2948) and SE (ports: 49999) OTA settings without additional modifications.

### EXAMPLES

Details of the operation of certain examples of the networking applications 50, 52 are now described.

In one example, the application provides an SMS provisioning solution which assists users in configuring their handsets with correct socket communication settings for j2me (Java™ Micro Edition) applications.

As mentioned, in an example, the application 50 may be in the form of a client library that, once integrated into a host (gaming) application, performs testing and configuration of the communication options on the handset or mobile device 12; provides a user an interface to guide the user through these testing and configuration steps; and sends a request for configuration details, if necessary. The application also interfaces with corresponding server side software.

When the host application loads it initialises the application 50 which is in the form of a client library and transfers application control to the application 50, including access to the MIDlet (Mobile Information Device Profile applet) display. The client library checks if a known connection type is stored and, if present, notifies the host application to continue execution with specified connection type.

If no known connection type is specified the client library performs testing of available communication options interacting with the user as appropriate and if no suitable connection type is found, the application 50 sends an SMS request for configuration settings (including user agent and operators SMSC number so that appropriate settings can be identified) and exits. It is expected that the communication options will be retested on the next application load. Once the user has installed the requested settings the application will identify a working connection and the user will be transferred to the game.

The host game application may request the retesting of available communication types at any time by invalidating the stored communications type flag, for example, if the communications type indicated by the client library is not leading to a successful connection to the game. In such a case the connection options are re-tested on the next load of the application.

The testing of the available communications options is performed by attempting to connect to socket and HTTP echoing servers, submitting data and reading responses in order to obtain a “match”. Any other outcome is considered a failed connection attempt.

The SMS server receives configuration requests from the transport layer (currently employed using a GSM Modem), which verifies that incoming parameters are known and then sends predefined configuration messages in response.

### Components

### Communications Check Client Library

The communications check library (configuration module) provides the following functionality: logic to perform the testing of the available communications options; the sending of required SMS requests for configuration information; and the handling of user flow (implemented using MIDP forms).

In an example, this library is implemented in the form of the following two classes in the host application:
1. The Interface CommCheckResultNotifier Class
   The host application MIDlet implements this interface and passes it to the CommunicationsCheck class upon initialisation.
2. The CommunicationsCheck Class
   This class should be called during application initialisation (upon the first call to the MIDlet.startApp( )method). It will check for available communication options and will call specified CommCheckResultNotifier with one of the following constants specified in the CommCheckResultNotifier class: —
      a. CommCheckResultNotifier.COMMUNICATIONS_SOCKET
         Host application should connect using socket connection.
      b. CommCheckResultNotifier.COMMUNICATIONS_HTTP
         Host application should connect using HTTP connection.
      c. CommCheckResultNotifier.COMMUNICATIONS_UNAVAILABLE
         No connection is available (normally not called).
      d. CommCheckResultNotifier.COMMUNICATIONS_EXIT_REQUEST
         Host application should terminate and exit. This will happen either if the user has sent an SMS request or if the library has requested that WAP a page be opened after the application exits.
      e. CommCheckResultNotifier.COMMUNICATIONS_RESULT_UNKNOWN
         Indicates that there was an internal error in the client library and it cannot continue execution.

An example MIDlet application is provided below:

```
public class CommCheck extends MIDlet implements CommCheckResultNotifier {
    Display d;
    SplashScreen splash;
    //used for
    private String socketUrl = “socket://193.195.77.182:9001”;
    private String httpUrl = “http://193.195.77.182:9000/HttpServer/hs”;
    private String smsServiceNr = “00447867808327”;
    public CommCheck( ) {
        splash = new SplashScreen( );
    }
    public void startApp( ) {
        d = Display.getDisplay(this);
        d.setCurrent(splash);
        CommunicationsCheck c = new CommunicationsCheck(this, socketUrl,
httpUrl, smsServiceNr);
        String userAgent = System.getProperty(“microedition.platform”);
        String midletVersion = getAppProperty(“MIDlet-Name”) + “/” +
getAppProperty(“MIDlet-Version”);
        //Control is transferred to CommCheck at this point
        //CommCheck may grab MIDlet Display at this point
        //to interact with user if neccessary
        c.findConnection(d, userAgent, midletVersion);
    }
    ...
    //Control returns to host application with this call
    //if CommCheck has used Display to interact with user
    //it will be restored to the state it was in, before
    //CommunicationsCheck.findConnection call.
    public void commCheckFinished(int result) {
        if (result == CommCheckResultNotifier.COMMUNICATIONS_EXIT_REQUEST)
{
            notifyDestroyed( );
        } else {
            splash.setString(“Result: ” + result);
            splash.repaint( );
        }
    }
}
```

### Communications Testing

Communications testing is performed by creating a separate thread that attempts to connect to either socket (TCP/IP) or HTTP servers and notifies the main thread as soon as it can determine whether a successful connection has been made. Since it is not possible to control the connection timeout for such connections, in an example, the timeout is artificially limited to 30 seconds by waiting for a notification from the connection testing thread for only a limited period of time, for example, using an Object.wait(30*1000) function call.

In some examples, a JSR-120 (Java™ Wireless Messaging API) compatible mobile device is required.

Since it is not possible from within the application 50 to determine the actual moment when the mobile device connects to the internet (since this is handled in the mobile device's native stack), there is a possibility that the specified timeout may expire while the application is still waiting for user confirmation to connect to the server 40. To reduce this risk, the application 50 is adapted to cause the mobile device to vibrate at moments when user attention is required.

### CommCheck MIDlet Applet

The CommCheck MIDlet applet provides a standalone environment to test communications check library independently of the gaming application.

The CommCheck MIDlet emulates the game by providing a canvas based main screen and the ability to retest connections or reset the client library status when the client library has released the user to the gaming screen.

### SMS Server Example

An example of the implementation of the SMS sever is now described.

In an example, the SMS Server is a Java™ application running on the server application 52 that receives, processes and dispatches SMS configuration messages in response to configuration request messages received from the application 50 running on the mobile device 2.

The SMS server consists of the following modules:
A ProvisioningServer module which parses incoming messages and prepares response messages, and includes:
   A configuration reader which reads the configurations from the properties files and holds them in memory
   A configuration refresher which is a thread that periodically checks the properties files for changes and updates the in-memory configuration accordingly
A MessageDispatcher module which is a thread-isolated queue that queues outgoing messages and ensures that transport layer is operated from a single thread.
A data model (SMSMessage)
A transport layer which is an abstract transport layer for SMS, and defines a bi-directional interface for sending and receiving messages, and also incorporates basic lifecycle control. This also includes:
   Implemented transport layer: SMSLib transport layer. This uses a GSM modem to send/receive messages. Additionally it has its own properties file to define the COM port and GSM modem dialect to be used.

### Incoming Messages Format

The SMS server expects messages to be in the following format:

“<user agent>:<SMSC number>:<arbitrary version information>”.

### Where: —

User agent is a user agent string as indicated in the devices.properties file. It is acquired on the device from the JAD file, or through a System.getProperty(“microedition.platform”) call.

SMSC number identifies the operator as defined in smscmappings.properties file. This is acquired on the device through the System.getProperty(“wireless.messaging.sms.smsc”) call (support for this property is mandatory for JSR-120 compliant devices).

Version information is information about the version of the game. This can be used to track later usage.

Upon receiving an incoming message, the SMS server splits it into the above three parts and if corresponding device configuration containing requested operator (mapped through smscmappings.properties file, see below) configuration settings is found, replies with messages defined in the device configuration (containing instructions on how to activate configuration and any marketing messages).

If incoming message is in an incorrect format or if no matching configuration or operator is found, an SMS with invitation to contact customer support is sent.

### Configuration

Provisioning configurations, messages and operator-SMSC mappings are set using a number of properties files:
devices.properties
   Defines the mapping between the user agent received in the request SMS and the configuration file for a particular device.
smscmappings.properties
   Defines the mapping between the SMSC numbers received in requested SMS and the operator name. The operator name is also used in the device configuration file.
Device configuration file (name as defined in devices.properties file)
   Defines the messages and properties for a particular device. Specifically:
      message1—message to send out to user (optional, up to three messages may be defined)
      message2—message to send out to user (optional)
      message3—message to send out to user (optional)
      settings.<operator name (as defined in smscmappings.properties)>—PDU encoded message containing WSP header and WBXML encoded settings. There may be multiple settings sections per configuration (one for each operator name)
      settings.<operator name>.sourceport—source port for SMS message. Allows support for multiple provisioning standards. The default is 0 for Nokia/Ericsson CP or 2948 for OMA CP 1.0/1.1
      settings.<operator name>.destinationport—destination port for SMS message. The default is 49999 for Nokia/Ericsson CP or 2948 for OMA CP 1.0/1.1

### Configuration Files

OTA (Over-the-air) client provisioning (defining settings for phone to use) is performed using one of the following specifications:
Older phones (Samsung™ D500/Z500 in particular):—The Nokia™/Ericsson™ CP 6.0/7.0/7.1 specification
Most other devices: —OMA (Open Mobile Alliance) CP 1.0/1.1 specification

In order to prepare a configuration message the following items are required:
A configuration XML document prepared in accordance with relevant specification converted into WBXML (WAP Binary Extensible Markup Language) format.
An SMS message prepared with a UDH (User Data Header) specifying the source/destination ports in binary format (8 bit). This is split into multiple messages if necessary.
A WSP (Wireless Session Protocol) header is for user data (WBXML) containing (in the case of the OMA CP 1.0/1.1 specification) a user authentication flag (USER_PIN) and a SHA1-HMAC signature of the WBXML document hashed by the pin number that the user has previously entered to authenticate the settings installation (“1234” recommended).

The SMS OTA CP message is then prepared by forming a message payload based on the WSP and the WBXML. The SMS UDH is then formed by specifying the source/destination ports and, if the payload is longer than 140 bytes (the maximum size per message), specifying that the message be split into a number of separate messages, each message in the sequence containing up to 140 bytes from the payload. The SMS OTA message is then sent.

### Preparing Provisioning Messages

For simpler process use WbxmlUtils, for example, to handle the forming of a SMS PDU (Protocol Data Unit) with a hex-encoded SMS header, UDH and a payload. This provides:
Conversion from source XML to WBXML
Preparation of a WSP header, including calculating and including WBXML signature for USER_PIN authentication method
A concatenated SMS header, including the UDH and WSP headers and configuration documents
A prepared message in PDU format in the format of <input xml file name and extension>.message

In an example, original content provisioning messages can be extracted from the operator's configuration interface using a GSM modem and the SMS Server.

Step by step preparation of a provisioning message is as follows:
1. Identify handset and operator that requires configuration
2. Identify handset user agent that will be present in runtime
3. Extract operator supplied CP configuration message and document
   a. Use SMSServer with GSM modem to acquire PDU(s) of configuration message
   b. Use PduSpy (http://www.nobbi.com/pduspy_frame.htm) to identify and extract payload (WSP+WBXML) from PDU(s)
   c. Identify WBXML part of payload (look for signature bytes “030b6a” that identify beginning of WBXML documents (Note: the signature MAY be different if some exotic dialect of WBXML is used)
   d. Use wbxml2xml (http://libwbxml.aymerick.com) to convert to XML format
4. Modify/add APN settings and bootstrap context in the XML message, set user friendly APN names
5. Use WbxmlUtils to convert XML to SMS PDU
6. Identify settings activation sequence on the handset
7. Add properties file to SMSServer
   a. Add text messages describing activation sequence
   b. Add settings PDU for relevant operator
   c. Set source and destination ports for particular settings
8. Add handset user agent and properties file name to devices.settings file in SMS Server. If the SMS Server is running the added configuration will be loaded and available within 5 seconds.

### Socket Connection Test Server

A socket connection test server is a standalone Java™ application that accepts socket connections from the client library. Multiple connections at a time are supported (each connection spawns a separate thread).

Upon connection the socket connection server reads a number of variables from the socket using DataInputStream and writes a confirmation string.

### Variables Protocol Dump

Variables between the communicationscheck client library and the Socket and HTTP servers are sent using DataInputStream in the following format:
int variable indicating UTF variable following (1) or end of variables (0)
UTF/String variable if int variable was 1

After receiving int variable “0” socket server writes UTF string “OK” as response and closes streams. Sample session may appear as follows:
1. Client sends data
   a. writeInt(1);
   b. writeUTF(variable 1);
   c. writeInt(1);
   d. writeUTF(variable 2);
   e. writeInt(0);
2. Server confirms received data
   a. writeUTF(“OK”);

### HTTP Connection Test Server

The HTTP connection test server is a servlet (selected for ease of implementation reusing Tomcat's HTTP handling layer) that parses requests for variables and replies with a DataStream-encoded body “OK”. The parsing of variables is the same as in the case of Socket connection test server.

### Installation Details

### SMS Sever

For the SMS Server to operate using a GSM Modem transport layer it requires a Java™ Communications API to be installed on the server 40. This allows Java™ applications to access and operate using serial communications.

The GSM modem transport layer uses a phone to receive and send SMS messages, for example, a Nokia™ 6230/6230i handset provides a stable GSM modem stack and requires an active SIM to operate. The phone is also set up to provide unconditional call forwarding to the individual responsible for managing the provisioning infrastructure.

### HTTP Server

In an example, the server 40 comprises an HTTP server, which is a web application intended to be run inside a web applications container, for example, Apache Tomcat.

This is set up in a web applications container to listen on port 9000, with the IP address and port known and accessible from Internet.

### Socket Server

The server 40 may also, in one example, include a socket server, in the form of a standalone Java™ application that listens for socket connections on port 9001.

### Client Library

The client library provided as part of the client side of the networking application 50 requires the following parameters to operate:

Infrastructure parameters (which must be known at build time and are common across all handsets):
The IP address/port of HTTP server
The IP address/port of socket server
The number of the SIM used in the SMS server.

Application parameters (which are set by the application and dependant on the version/handset):
User agent
SMSC number
Client application ID/version string

In summary, a networking application, method or system is provided which is adapted to connect a mobile device to a server so that a user of the mobile device is able to execute a networked application, such as an online game, which is executed at least in part on the server.

One preferred example of the implementation of the application, method or system may operate in the following way: —
Attempts to use all APNs using TCP/IP
   If successful, then connects and congratulates the player, or
   If unsuccessful, uses information about the APN to determine the time prior to attempting to connect again, and then tries to connect again without informing the player
If unsuccessful, then switches to HTTP and tries all APNs, and then either
   If successful, then connects and automatically requests the download of a TCP/IP APN, or
   If successful, uses information from the http or WAP APN to request the correct TCP/IP APN, or
   If successful, uses information automatically retrieved from the phone to request the correct TCP/IP APN, or
   If successful, uses information manually entered by the player to request the correct TCP/IP APN, or
   If successful, uses information provided as part of the downloaded game to request the correct TCP/IP APN.
      If unsuccessful or if disconnected uses information about the APN to determine the time prior to attempting to connect again, and then tries to connect again without informing the player
If unsuccessful, uses a different communications channel (e.g. SMS) to automatically request the correct TCP/IP APN
   Using information from the
      Game itself
      Existing APNs
      The phone
      Provided by the player

### Dual Connection

In certain examples, the networking application 50 is adapted to establish a further network connection. Details relating to such examples are now described with reference in particular to FIGS. 7 to 9.

As shown schematically in FIG. 7, the mobile device 12 runs or executes a client networking application 50 which is, in use, connected via a pair of socket-based network connections 200, 202 to a corresponding server networking application 52 hosted on a server 40. As mentioned above, these networking applications 50, 52 form part of an online multiplayer gaming application (not shown), for example, an online poker game hosted on the server 40 and accessible to a plurality of similar mobile devices 12.

The applications 50, 52 include a network connection means in the form of a network connection module which establishes the network connection between each of the respective applications 50, 52.

It will be appreciated that the connection between the applications 50, 52 is usually achieved via a gateway, for example a GGSN (Gateway GPRS support node) 38 and an associated APN (Access Point Name), since the application 52 is executed on a server 40 connected to the internet 20, whilst the application 50 is executed on a mobile device 12 connected to a mobile communications network.

In an example, the socket-based connections 200, 202 are in the form of TCP/IP based connections between the applications 50, 52. In other examples the connections might use HTTP or other communication protocols.

As shown in FIG. 7, the socket-based connections 200, 202 are independent of one another. Furthermore, as will be discussed in further detail below, each connection 200, 202 provides a separate communication channel, each of which are configured to handle one way simplex communication. Thus, one connection 200 handles the transmission of data and/or messages from the client application 50 to the server application 52, and the other connection 202 handles the reception of data and/or messages from the server application 52 to the client application 50. Thus, a robust dual simplex connection is provided between the applications 50, 52. This enables mobile devices 12 running the multiplayer gaming application to communicate effectively with the host gaming application, running on the server 40, and other mobile devices 12.

With reference to FIG. 8 the operation of the network connection module is now described in further detail. In this example, the client application 50 initiates the setting up or establishment of the socket connection. In particular, as shown in step 206, the (client) network connection module initiates the setting up of a first socket-based connection with the application 52. Further details relating to the establishment of this first socket-based connection are discussed in further detail above, with reference to FIGS. 1 to 6.

A communications handshake is implemented as part of the setting up of the TCP/IP socket-based connection. Once this handshake has been successfully completed, and the client application 50 has received the relevant network session ID from the server application 52 (as shown in step 208), the networking module will initiate the setting up of a second socket connection (indicated at step 210). The session ID enables the application 50 to communicate directly with the application 52, and in an example, is implemented as part of the set up of the session layer in the OSI networking stack.

The setting up of this second socket connection involves using the same settings that were used to set up the first socket connection (i.e. the network connection module uses the same TCP APN details and port numbers that were used to set up the first network connection).

When the client application 50 requests the second connection the server application 52 will detect that the request originates from the same client and will accordingly associate the sockets with the same session within the application 52. In particular, the session ID assigned to the second connection will be related to session ID which was assigned to the first connection.

Once the second socket connection 202 has been established, a channel configuration means, in the form of a channel configuration module, configures each of the connections (as shown in step 214). In particular, one connection 200 is designated to be a transmitting channel, which will handle all data and/or messages which are transmitted from the client application 50 to the server application 52, and the other connection 202 is designated to be a receiving channel, which will handle the receipt of all data and/or messages from the server application 52.

Additionally, each channel is also associated with a particular software thread running within the applications 50, 52, for example, the transmitting channel may be associated with a “write” thread which is adapted to write data to the server application 52, and the receiving channel may be associated with a “read” thread adapted to read data from the server application 52.

The channels are configured by the configuration module to operate in a simplex communication mode (i.e. in a communication mode in which communication is allowed in one direction only). In this way, the pair of connections 200, 202 provide a dual simplex communication channel. In an alternative example the channels may be configured to operate in a half-duplex communication mode (i.e. in a communication mode in which communication is allowed in both directions, but only in one direction at any given time).

Once the channels have been configured, the channels are encrypted using appropriate key exchange techniques (as shown in step 216).

The applications 50, 52 also include means for detecting communication disruptions in the form of a detection module. In an example, the detection module detects software exceptions passed to the applications 50, 52 from a lower level networking application running on the mobile device 12. In the event that a communication disruption is detected, for example, a closed socket, the network connection module will establish a new socket connection (as described above) to replace the disrupted or closed connection. In an example, if a communication disruption is detected on either of the connections 200, 202, the network connection module will close both connections 200, 202 and then re-establish both network connections 200, 202.

### Backup Connection

In an example, as schematically illustrated in FIG. 9, the detection module monitors the receiving channel for the receipt of data (shown in step 220). If no data is received on the receiving channel within a predetermined time period, the detection module will determine that the network connection over which the receiving channel operates has closed (shown in step 222).

The detection module will then notify the network connection module that the receiving channel has been disrupted, and the network connection module will then transmit a reconnection request, using the transmitting channel, from the client application 50 to the server application 52 (shown in step 224) requesting the server application 52 to re-establish a connection to the client application. Upon receipt of this reconnection request the server application 52 will then establish a new socket connection to the client application 50. In this way the client receiving channel is reconnected. Thus, the active connection is used to reconnect the disrupted or closed connection.

Similarly, the server application 52 runs a corresponding detection module and if it detects that its receiving channel has closed or been disrupted it will transmit a reconnection request to the client application 50 requesting the client application 50 to establish a new connection to the server application 52.

In this way, with both applications 50, 52 monitoring each of their respective receiving channels, if either of the network connections is disconnected, disrupted or closed, one of the applications 50, 52 will detect this disruption and use the remaining active connection to initiate the reconnection of the disconnected, disrupted or closed connection.

### Dynamic Connections and Protocols

In certain situations the networking application 50 is adapted to dynamically change network communication protocols.

Network connections, as described above, vary greatly as to their speed and reliability depending on factors such as the network provider, the gateway, mobile device/handset type, mobile handset/firmware version, location, and other factors such as the time of day. In particular, the firmware version installed in mobile devices/handsets varies considerably causing challenges in the choice of communication protocol most suitable for that device.

In order to overcome these problems a number of communication protocols are used: HTTP, and TCP/IP dual connection TCP/IP, as well as one further network communication protocol, UDP (User Datagram Protocol). UDP is known as a connectionless protocol that does not require any set up (handshaking) prior to sending data. A message, in the form of a datagram, is simply sent to a receiving port with no requirement for acknowledgement of receipt, and with only simple checks, such as a checksum, performed to determine the integrity of the data. This can improve the transfer speed of the data and also remove the processing overheads associated with other transfer protocols, such as TCP or HTTP. However, UDP will not always provide the best solution to the problem. To overcome the associated problems the communication protocols are dynamically switched, on-the-fly; this is discussed in further detail below.

FIG. 10 shows a schematic diagram of client and server systems for providing mobile gaming applications, such as multiplayer poker. In overview, the client 12, such as a mobile communications device, comprises a processor and memory (not shown), an application 50, a general gaming platform (GGP) 1000, a message layer 1002, a data layer 1004, an optional transaction protocol layer 1006, a connection layer 1008, and an API 1010. In addition the client 12 has a priority list look-up table 1012 stored in memory, and a selection engine 1014 adapted to select the communication protocol based on the priority list look-up table 1012. The selection engine also includes a counter (not shown). In addition, there is provided a condition sensor 1016, adapted to sense the conditions within the client, such as the battery level and signal level.

In detail, the client 12, a mobile device, such as a cellular telephone handset, hosts an application 50, such as a gaming application, in particular an online poker game. The application 50 sits on top of the GGP 1000. In order to communicate with the server 40, the client 12 can utilise a number of different communication protocols. For example, the client can utilise any of the above described connection protocols (HTTP, TCP/IP, dual connection TCP/IP or UDP) and, via the message layer 1002, data layer 1004, optional transaction layer 1006, connection layer 1008 and the API 1010, communicate with the server 40, via the mobile telecommunications network 10.

The GGP 1000 allows any one of a number of applications to be executed on the mobile device. The GGP communicates with the message layer 1002. The message layer 1002 receives commands from the application 50, via the GGP 1000. For example, when the online poker game is in use, commands such as “FOLD”, “BET” or “CHECK” would be required to be transmitted. The message layer then passes the message to the data layer 1004.

Independent of the communication protocol the data layer 1004 encrypts, and decrypts upon receipt of incoming data, the message and then passes the message to the transaction protocol. The transaction protocol adds a transaction ID to each message, or portion of message, that is sent over the network. The transaction ID ensures that every message, or portion of message, is received by the server. The transaction ID will increment one number at a time and therefore the transaction IDs should arrive in consecutive order at the server. Upon receipt of each packet of data/datagram the server sends an acknowledgement that it has received the packet/datagram. If the client does not receive an acknowledgement it re-sends the message.

The connection layer 1008 provides the communication protocols that are used to connect to the mobile telecommunications network 10. The connection layer 1008 is provided with four connection protocols; HTTP, TCP/IP, dual connection TCP/IP, and UDP. However, it is envisaged that any number of protocols may be used. The connection layer 1008 is in communication with the selection engine 1014 The selection engine is in communication with the priority list look-up table 1012 and uses the priority list to decide which communication protocol to use. The connection layer 1008 first attempts to create a connection with the communication protocol with the top priority; if this is successful then no further connections are attempted. However, if the connection attempt is unsuccessful the connection layer 1008 will attempt to create a connection using the protocol with the next highest priority, and so on until a successful connection is established. The counter within the selection engine is used to progress through the priority list. Once a connection is established a “connection message” is sent from the client to the server indicating which communication protocol is in use and which protocols were attempted to be used before the successful connection was established. Using the priority list of communication protocols allows the client to establish the most effective connection available at that time. The communication protocol with the top priority is chosen as being the most effective protocol for that particular client. This may be chosen iteratively using the data from many connection sessions by that particular client, or by the server using data from many connections sessions by similar clients.

FIG. 11 shows the process involved in establishing a connection. Step 1500 initiates the attempt to create a connection using one of m communication protocols; in a specific example m=4 (HTTP, TCP/IP, dual connection TCP/IP, and UDP). The parameter n indicates the number of protocols that have been attempted, and is used to select the priority of the protocol within the priority list 1012. Step 1502 attempts to connect to the network using the communication protocol with priority n; if the connection is successful a network connection is established 1506, and may be utilised by the client. If the attempt is not successful as long as step 1508 is negative—the communication protocol was not the last in the priority list—the next protocol is used to attempt a connection. If the attempt is not successful and step 1508 is positive—the communication protocol was the last in the priority list—a message is displayed on the mobile device indicating that it was not possible to establish a network connection, step 1510. In more detail, the selection engine 1014 is used to count the number of communication protocols attempted so far, to select the next communication protocol, and to output when all of the communication protocols have been attempted.

If a connection is established, step 1506, and n does not equal 1, step 1512, then step 1514 will initiate a message to be sent to the server indicating the communication protocol used, and the protocols that were attempted to be used. The final step 1516 provides that the established connection is utilised by the mobile device.

Referring again now to FIG. 10, the client 12 is in communication with the mobile telecommunications network 10, as described above. The mobile telecommunications network 10 enables the client 12 to communicate with the server 40, and the download server 1200, via the internet 20. In overview, the server 40, as described above, comprises an application 52, a GGP 1100, a message layer 1102, a data layer 1104, an optional transaction protocol 1106, and a connection layer 1108. In addition the server 40 further comprises a switching server 1110, a connection database 1112, a network condition monitor 1114, and a manual switching server 1116.

In detail, and regarding specifically the server 40, the server (a remote device), upon receipt of a message, carries out the operations by the client in reverse, as described above. The transaction protocol 1106 receives the transaction ID and determines whether any message, or portion of the message, has not been received. If the expected transaction ID has been received the server sends an acknowledgement to the client. The message is then passed to the data layer 1104, where the message is decrypted and passed to the message layer 1102. The message is then passed up through the GGP 1100, and finally onto the application 52, where the action appropriate to the message is performed.

In further detail, and regarding the transaction protocol, when for example UDP is used with the gaming application, and especially with an online poker game, it is critical that all of the information sent from the server to the mobile device is received, as the gaming application may crash if it does not receive a critical packet of information. Therefore, a transaction protocol is provided to ensure all of the data sent, either from the mobile device to the server or vice versa, is received. The transaction protocol sits on top of the network protocol in use and sends transaction IDs with each datagram. In addition the transaction protocol requires confirmation to be sent that the datagram has arrived successfully.

In further detail, and regarding the switching server 1110, the initial “connection message” sent by the client to the server is passed through the switching server 1110 to the connection database 1112 where it is stored. The switching server 1110 uses the information contained within the “connection message” to change the communication protocol priority where necessary.

The algorithm that the switching server 1110 uses to change the communication protocol priority is dependent on the previous priority, the successful protocol used and the protocols that were attempted to be used. In an example, the original priority list for a specific mobile device, as located in the client, is as follows:
1. TCP/IP
2. UDP
3. TCP/IP dual connection
4. HTTP

When the client fails to establish a connection using TCP/IP it attempts to use UDP, then TCP/IP dual connection and finally HTTP. In this example, if the eventual connection that is established utilises TCP/IP dual connection then the switching server would initiate a change in the priority list in the client to:
1. TCP/IP dual connection
2. TCP/IP
3. UDP
4. HTTP

Therefore, the next time this particular mobile device attempts to connect to the server the first communication protocol to be attempted would be TCP/IP dual connection. The priority list will adapt to the changing circumstances of the mobile device and ensure that the most appropriate communication protocol is used at all times. The switching server implements the change to the client priority list, via a message sent to the client over the established connection.

The switching server 1110 and the manual switching server 1116 perform the same task, implementing a change in the communication protocol used by the client. However, the switching server 1110 implements the change automatically using in-built algorithms, and the manual switching server 1116 is controlled manually through external input, by a human for example.

The manual switching server 1116 can be used to implement a change in the communication protocol used by the client; this can allow for the network to be monitored and the communication protocol to be altered in response to the network conditions to provide the best connection possible at that time.

By use of another message sent to the client the server can implement a change in the communication protocol without the user of the mobile device being aware of such a change. On receipt of the message the client creates a new thread and a new connection over that thread using the communication protocol instructed by the server. The previous connection and thread expire in due course.

For each connection session information is stored in the connection database 1112 regarding the type of the mobile device, the network provider, the communication protocol used, the time of day, the geographic location, and other such parameters. The information can then be used to update the priority list on the client. The large amount of detailed metrics gathered on the performance of the various protocols used enables a detailed priority and switching system to be implemented. A list is provided below detailing examples of the metrics gathered and the way in which they may be used, although other uses are of course possible:
The signal level of the mobile device/handset—it may be known, for example, that when the signal level falls below a certain level one communication protocol is more effective than another.
Time of day—it may be known, for example, that one communication protocol works better than another in the evening.
Geographic location—it may be known, for example, that one communication protocol works better in one location than another.
Signal quality—it may be known, for example, that when the signal is intermittent TCP (with its associated acknowledgements) is the best protocol to use.
Battery power—it may be known, for example, that when the battery level falls below a certain level UDP (with less processing overheads) is better than TCP.
The network—it may be known, for example, that a particular network such for example as the Vodafone™ network works better with UDP than TCP.

As will be appreciated, some of these parameters are sensed in the mobile device itself, whilst others are external to the mobile device. At least some of the external parameters are sensed by the network condition monitor, and stored within the connection database.

Of course, the communication protocol used may be dependent on a more than one metric or parameter. For example, it may be known that on one network in the evening TCP is the most appropriate protocol to use.

In addition, when the connection is made using wireless LAN the protocol used to connect to the server is dependent on the ISP (Internet Service Provider) providing the internet connection. Therefore, the ISP is also used as a parameter for choosing the connection protocol.

Further examples are now provided of the parameters associated with the switching of protocols:
A specific network works better with UDP in the afternoon and in TCP in the morning.
In some geographic areas it is preferred to use one protocol and not another.
When specific mobile devices/handsets and firmware have difficulties with one protocol the priority can be changed.

In the preferred embodiment, each mobile device is provided from the start with all of the communication protocols. The protocol selected for use by the mobile device is based on its given priority relative to the other protocols. The priorities may be based on the prior knowledge of the network characteristics. For example, one network may have excellent performance using TCP/IP, while a different network has excellent performance using UDP, but not with TCP/IP. Therefore, the priority list for any given client is set initially using the information already known. It may then evolve after a number of connection sessions in order that the user of the mobile device will be provided with an optimal service at all times with no requirement to reconfigure the connection manually.

In this way the system provides automatic fault detection and self-healing networks.

In an alternative embodiment, some or all of the devices, such as the switching server 1110, connection database 1112, and network condition monitor 1114, are local to the client (the mobile telecommunications device). Therefore, the client is provided with the means to initiate a change in the communication protocol without intervention from the server 40.

### Connection Timeout

A timeout feature is provided in order to reduce the time taken to detect a failed connection. The timeout feature is in addition to the timeout feature as provided by some communication protocols such as TCP.

TCP checks to make sure that no packets are lost by giving each packet a sequence number, which is also used to make sure that the data are delivered to the client/server in the correct order. The client/server sends back an acknowledgement for packets which have been successfully received; a timer at the sending TCP will cause a timeout if an acknowledgement is not received within a reasonable round-trip time RTT, and the (presumably lost) data will then be re-transmitted. The RRT in TCP is generally initially set to of the order of 1 second. TCP will then double the timeout value when a packet is not acknowledged, and therefore the timeout will grow exponentially. Although the timeout is capped at an arbitrary length long delays are experienced after only a few attempts to resend the data. Therefore, establishing that the connection has failed altogether provides a delay that is too long for mobile device applications such as multiplayer online poker.

The additional timeout feature provides a fixed delay time after which the connection is assumed to have failed. In a specific example the delay time used is 20 seconds; however, the delay time can be any other length of time suitable for the particular application, such as 5-60, 10-40, 15-25 or 18-22 seconds. The timeout period is such that the TCP timeout feature has enough time to request the data to be re-sent a number of times to ensure that the connection has failed, and it is not just delayed. Once the timeout is triggered a new connection is established within a new thread. Within the Java™ environment a thread can not be forcefully terminated once it has been established, and therefore a new thread is required to establish a new connection. The old connection and thread are ignored and are eventually terminated automatically by the system. For each read and write operation the timeout feature is run on a different thread to check the time passed between read/write operations.

As shown in FIG. 12, the client 12 includes the connection layer 1008, as described above, the other features as described in association with FIG. 10 (not shown), and a further timer 2000. The server 40 also includes the connection layer 1108, as described above, the other features as described in association with FIG. 10 (again, not shown), and a timer 2002. The timer times the time taken between sending a packet and receiving the acknowledgement that is has arrived at the recipient over the established connection 2004. If the time exceeds the pre-determined figure, 20 seconds in this example, the timer initiates a new connection 2006 and re-sends the packet. The original connection 2004 is then allowed to be terminated automatically by the system.

FIG. 13 shows the process through which the timeout feature operates. Once a connection is established, step 1300, data is sent to the recipient, step 1302. A timer is then started, 1304, in an alternate thread, and then the client/server waits for an acknowledgement to be received 1306. This process loops through steps 1306 and step 1308 until either an acknowledgement is received and the client/server proceeds to step 1310 to prepare to send a new packet of data, or the timer reaches 20 seconds (or any other suitable time period). If the timer reaches 20 seconds step 1312 establishes a new connection as the previous connection is deemed to have failed. The whole process begins again by attempting to send the original data at step 1302.

### Disconnection Protection

When disconnection occurs for whatever reason, the mobile device is adapted to provide immediate feedback on the disconnection event, and will provide a timeout feature to enable the user to resume if reconnection is feasible.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A networking system for a mobile communication device, said system comprising: means for establishing a connection with a remote device using any of a plurality of communication protocols; means for selecting a communication protocol from said plurality of communications protocols for use in attempting establishment of said connection; wherein each of said plurality of communications protocols have a predetermined priority, and wherein said selection means is configured to select a first of said protocols according to its priority.

2-240. (canceled)
